(19) United States
(12) Patent Application Publication
(10) Pub. No.: US 2014/0179020 A1
(43) Pub. Date: Jun. 26, 2014

(54) Methods and Apparatus for Identifying Ion Species Formed during Gas-Phase Reactions

(71) Applicant: David A. WRIGHT, Livermore, CA (US)

(72) Inventor: David A. WRIGHT, Livermore, CA (US)

(21) Appl. No.: 13/721,603

(22) Filed: Dec. 20, 2012

(51) Int. Cl. G01N 27/62

(52) U.S. Cl. CPC G01N 27/62; G06F 19/70
USPC 436/173; 422/98; 702/23

(57) ABSTRACT

A method for matching each of a plurality of progenitor ion types to respective product or fragment ion types, comprising: generating the plurality of progenitor ion types over a time range by ionizing compounds eluting during the time range using an atmospheric pressure ion source; generating the product or fragment ion types within a pressure range of 750 mTorr to atmospheric pressure in an ionization chamber or first vacuum chamber; detecting abundances of the plurality of progenitor ion types and the product or fragment ion types using a mass analyzer; calculating a plurality of extracted ion chromatograms (XICs) relating to the detected abundances; automatically detecting and characterizing chromatogram peaks within each XIC; automatically generating synthetic analytical fit peaks; performing cross-correlation score calculations between each pair of synthetic analytical fit peaks; and recognizing matches based on the cross correlation scores.

### FIELD OF THE INVENTION

This invention relates to methods of analyzing data obtained from instrumental analysis techniques used in analytical chemistry and, in particular, to methods of automatically identifying product ion species and fragment ion species formed in gas phase reactions at pressures ranging from 750 mTorr to atmospheric pressure.

### BACKGROUND OF THE INVENTION

Mass spectrometry (MS) is an analytical technique to filter, detect, identify and/or measure compounds by the mass-to-charge ratios of ions formed from the compounds. The quantity of mass-to-charge ratio is commonly denoted by the symbol “m/z” in which “m” is ionic mass in units of Daltons and “z” is ionic charge in units of elementary charge, e. Thus, mass-to-charge ratios are appropriately measured in units of “Da/e”. Mass spectrometry techniques generally include (1) ionization of compounds and optional fragmentation of the resulting ions so as to form fragment ions; and (2) detection and analysis of the mass-to-charge ratios of the ions and/or fragment ions and calculation of corresponding ionic masses. The compound may be ionized and detected by any suitable means. A “mass spectrometer” generally includes an ionizer and an ion detector.

The hybrid technique of liquid chromatography-mass spectrometry (LC/MS) is an extremely useful technique for detection, identification and (or) quantification of components of mixtures or of analytes within mixtures. This technique generally provides data in the form of a mass chromatogram, in which detected ion intensity (a measure of the number of detected ions) as measured by a mass spectrometer is given as a function of time. In the LC/MS technique, various separated chemical constituents elute from a chromatographic column as a function of time. As these constituents come off the column, they are submitted for mass analysis by a mass spectrometer. The mass spectrometer accordingly generates, in real time, detected relative ion abundance data for ions produced from each eluting analyte, in turn. Thus, such data is inherently three-dimensional, comprising the two independent variables of time and mass (more specifically, a mass-related variable, such as mass-to-charge ratio) and a measured dependent variable relating to ion abundance. The term “liquid chromatography” includes, without limitation, reverse phase liquid chromatography (RPLC), hydrophilic interaction liquid chromatography (HILIC), high performance liquid chromatography (HPLC), ultra high performance liquid chromatography (UHPLC), normal-phase high performance liquid chromatography (NP-HPLC), supercritical fluid chromatography (SFC) and ion chromatography.

FIG. 1 is a simplified schematic diagram of a general conventional mass spectrometer system comprising an atmospheric pressure ionization (API) source coupled to an analyzing region via an ion transfer tube. Referring to FIG. 1, an API source 12 housed in an ionization chamber 14 is connected to receive a liquid sample from an associated apparatus such as for instance a liquid chromatograph or syringe pump through a capillary 7. The API source 12 optionally is an electrospray ionization (ESI) source, a heated electrospray ionization (H-ESI) source, an atmospheric pressure chemical ionization (APCI) source, an atmospheric pressure matrix assisted laser desorption (MALDI) source, a photoionization source, or a source employing any other ionization technique that operates at pressures substantially above the operating pressure of mass analyzer 28 (e.g., from about 1 Torr to about 2000 Torr). Furthermore, the term API source is intended to include a “multi-mode” source combining a plurality of the above-mentioned source types. The API source 12 forms charged particles 9 (either ions or charged droplets that may be desolvated so as to release ions) representative of the sample.

The charged particles are subsequently transported from the API source 12 to the mass analyzer 28 in high-vacuum chamber 26 through at least one differentially-pumped vacuum chamber 18. In particular, the droplets or ions are entrained in a background gas and transported from the API source 12 through an ion transfer tube 16 that passes through a first partition element or wall 11 into the chamber 18 which is maintained at a lower pressure than the pressure of the ionization chamber 14 but at a higher pressure than the pressure of the high-vacuum chamber 26. Additional differentially-pumped vacuum chambers may be present between the chamber 18 and the high-vacuum chamber 26. The pressure of the ionization chamber 14 may generally be at or approximately at atmospheric pressure (101 kPa). The pressure of the first differentially-pumped vacuum chamber 18 may range from approximately 750 mTorr (100 Pa) to as great as approximately 50 Torr (6.67 kPa). The ion transfer tube 16 may be physically coupled to a heating element or block 23 that provides heat to the gas and entrained particles in the ion transfer tube so as to aid in desolvation of charged droplets so as to thereby release free ions.

Due to the differences in pressure between the ionization chamber 14 and the first differentially-pumped vacuum chamber 18 (FIG. 1), gases and entrained ions are caused to flow through ion transfer tube 16 into the chamber 18. The ion transfer tube may also serve as a counter-electrode for the API source so as to (in conjunction with another electrode at the source) initiate ion formation at the source—for instance, so as to form a Taylor cone in an ESI source or a plasma in an APCI source. The preferential flow of ions or other charged particles, relative to neutral gas molecules, into the ion transfer tube 16 is enhanced by an electrical potential difference applied between the API source 12 and the inlet end of the ion transfer tube, as schematically illustrated in box 40. A plate or second partition element or wall 15 separates the chamber 18 from either the high-vacuum chamber 26 or possibly a second intermediate-pressure region (not shown), which is maintained at a pressure that is lower than that of chamber 18 but higher than that of high-vacuum chamber 26. Ion optical assembly or ion lens 20 provides an electric field that guides and focuses the ion stream leaving ion transfer tube 16 through an aperture 22 in the second partition element or wall 15 that may be an aperture of a skimmer 21. A second ion optical assembly or lens 24 may be provided so as to transfer or guide ions to the mass analyzer 28. The ion optical assemblies or lenses 20, 24 may comprise transfer elements, such as, for instance, multipole ion guides, so as to direct the ions through aperture 22 and into the mass analyzer 28. The mass analyzer 28 comprises one or more detectors 30 whose output can be displayed as a mass spectrum. Vacuum port 13 is used for evacuation of the chamber 18 and vacuum port 19 is used for evacuation of the high-vacuum chamber 26.

In LC/MS, once a compound elutes from the column and is ionized, multiple gas phase reactions are possible, including adduction of species other than H+, dehydration and other losses of stable moieties, dimerization, and collection of multiple charges (charge transfer). The adducted species may be derived from solvent molecules or ions which are present in excess relative to analytes of interest. Collectively, these changes in mass can be thought of as “gas phase reactions” and are most probable within the region of space between the API source 12 and the exit aperture 22 of the first differentially-pumped chamber 22 (FIG. 1) of a mass spectrometer system. As a result of these reactions, a relatively simple spectrum may have each m/z value augmented by 5, 10 or more related m/z values that provide little additional information but greatly increase the complexity of analysis. This increased complexity may be especially problematical when multiple compounds co-elute, since it can be difficult to distinguish diagnostic primary ions (e.g., so-called “molecular ions”) from secondary ions produced by the gas phase reactions.

in various experimental configurations, an accelerating potential may be applied within or across the first differentially-pumped chamber 18 so as to cause fragmentation of primary ions by the process of collision induced dissociation. For example, if an ion transfer tube is employed, such as the ion transfer tube 16 illustrated in FIG. 1, an accelerating potential may be applied across the ends of the tube. For those systems that do not employ an ion transfer tube, an accelerating potential can be applied, for example, between entrance and exit apertures of the first differentially-pumped chamber. Using such so-called “in-source fragmentation” experimental configurations, it is possible to generate fragment ions for the purpose of structural and other studies without the need to employ tandem mass spectrometry. When multiple compounds co-elute, the use of in-source fragmentation can lead to difficulties in matching fragments to the correct precursor ion types because, unlike conventional tandem mass spectrometry, the precursor ions are not specifically selected beforehand. Additionally, gas phase reactions can lead to adduct formation, wherein the adducts are not only of precursor ions but also of fragment ions.

Even when the masses of interest are known, the presence of multiple potential adducts and other gas phase reactions can cause problems. An m/z value could equally likely be a protonated molecular ion, or an ammoniated adduct of a lighter molecule. From inspection of a single scan, there is no reliable way to differentiate these two possibilities. Differences in isotope ratios are likely to be extremely subtle, and could easily be less than an instrumental precision. The newly invented methods disclosed herein remove this complexity, at least for m/z values that are intense enough that they are found in several adjacent scans. These newly invented methods provide an independent means of differentiating m/z values, based on their physico-chemical interactions with a chromatographic column substrate.

### SUMMARY

The inventor of the present invention has realized that the technique of Parameterless Peak Detection (PPD) is useful to match ions that experienced the same chromatographic response and have similar lineshapes. Accordingly, methods of post-processing and real-time processing are described for filtering a scan and isolating m/z values that arise from a common primary ion, and modified by different adducts or by in-source fragmentation, or by both in-source fragmentation and adduct formation. The methods taught herein can be used to simplify experimental mass spectra as well as simplify elemental composition calculations, analyte identifications and, in some cases, structural analyses. For example, spectra may be simplified so as to only exhibit interrelated peaks through the removal of unrelated but coincidentally overlapping peaks. The coincidentally overlapping peaks may arise from product ions or fragment ions generated by gas-phase reactions at or near the ion source. When the interrelated peaks comprise an isotopic distribution pattern corresponding to a single ion, the subtraction of the coincidentally overlapping peaks from a mass spectrum can yield a simplified mass spectrum in which the isotopic distribution pattern may be recognized. In such cases, unambiguous recognition of the isotopic distribution pattern may not have been possible, prior to the elimination of the coincidentally overlapping peaks. The utilization of the present methods can thus improve the quality of elemental composition determinations that rely on interpretation of isotope distribution patterns. Further, the present methods require no prior knowledge of possible adducts or elements present.

Embodiments in accordance with the present teachings may employ a step of automatic peak detection—for example, by the methods of parameterless peak detection (PPD)—within each of a plurality of extracted ion chromatograms (XICs) derived from time-based mass spectrometry data obtained during LC/MS analysis. During this step, peak information is retained only for those ions for which chromatographic peaks occur. Further, as peaks are detected, they may be subjected to a few quality tests that are unique to XIC data. The automatic peak detection and location techniques do not make a priori assumptions about the particular line shape of the chromatographic or spectroscopic peak(s) and may fit any individual peak to either a Gaussian, exponentially modified Gaussian, Gamma distribution or to another form or to a composite form comprising more than one of the above peak forms.

in a subsequent step, the remaining ions are grouped by calculating the cross correlations of relevant parameters pairwise between the various remaining peaks. To perform this calculation, a vector is constructed for each peak, and a correlation coefficient is computed between each vector and every other vector. In some embodiments, each vector may include intensity values obtained from the parametric determination of peak shape. The time points of the intensity values cover the region of the XIC where PPD has determined that a peak exists. The correlation calculations identify groups of peaks the ions of which may be related as progenitor/products or progenitor/fragments.

According to first aspect of the invention, a method for matching each one of a plurality of progenitor ion types to its respective product or fragment ion types generated by reaction of the progenitor ion type, comprises: generating the plurality of progenitor ion types over a time range by ionizing compounds eluting from a chromatograph during the time range using an atmospheric pressure ion source of a mass spectrometer system; passing the plurality of progenitor ion types through an ionization chamber and a first vacuum chamber of the mass spectrometer system so as to generate the product or fragment ion types in said chambers during the time range, wherein pressures within said chambers are within a pressure range of 750 mTorr to atmospheric pressure; detecting abundances of the plurality of progenitor ion types and the product or fragment ion types using a mass analyzer of the mass spectrometer system; calculating a plurality of extracted ion chromatograms (XICs) relating to the detected abundances; automatically detecting and characterizing chromatogram peaks within each XIC and automatically generating synthetic analytical fit peaks thereof; performing a respective cross-correlation score calculation between each pair of synthetic analytical fit peaks; and recognizing matches between each of the progenitor ion types and to its respective product or fragment ion types based on the cross correlation scores.

According to a second aspect of the invention, there is provided an apparatus comprising: (a) a chromatograph for providing a stream of at least partially separated chemical substances; (b) a mass spectrometer having an atmospheric pressure ion source within an ionization chamber fluidically coupled to the chromatograph for generating one or more progenitor ion types from each chemical substance; (c) a first vacuum chamber of the mass spectrometer operable to receive the progenitor ion types, the interior of which is at a pressure in a range of 750 mTorr to 50 Torr; (d) a set of electrodes operable to apply an accelerating potential to the progenitor ion types within or across at least one of the ionization chamber or the first vacuum chamber so as to generate a plurality of product ion types by in-source fragmentation; (e) a mass analyzer and detector of the mass spectrometer operable to receive and detect abundance data for each progenitor ion type and each product ion type; and (f) a programmable electronic processor electrically coupled to the detector, the programmable processor comprising instructions operable to cause the programmable processor to: (i) receive the abundance data for each of the progenitor ion types and product ion types detected by the detector during a time range; (ii) automatically detect and characterize chromatogram peaks as a function of time for each of a plurality of mass-to-charge ratio ranges of the abundance data for the progenitor ion types and product ion types; (iii) automatically generate synthetic analytical fit peaks to the detected chromatogram peaks; (iv) automatically perform a respective cross-correlation score calculation between each pair of synthetic analytical fit peaks; and (v) automatically recognize matches between progenitor ion types and product ion types based on the cross correlation scores.

The various steps of calculating extracted ion chromatograms (XICs) relating to the detected abundances, automatically detecting and characterizing chromatogram peaks within each XIC, automatically generating synthetic analytical fit peaks, performing cross-correlation score calculations and recognizing matches may be performed automatically without input of any parameters by a user. In addition to recognizing matches between ion types, differences in mass-to-charge ratios between progenitor and product or fragment ions may be employed to determine the nature of gas-phase reactions that have occurred and to assign formulas or structures to various product or fragment ions.

After recognition of matches between progenitor ion types and product ion types or assignment of structures or formulas, mass spectra may be simplified by retaining information pertaining only to certain diagnostic ion types, such as molecular ion progenitor ion types or singly-protonated progenitor ion types. The elimination of interfering lines corresponding to ions generated by gas-phase reactions (such as adduct formation or in-source fragmentation_by subtraction of these lines from a mass spectrum can, in some instances, enable unambiguous recognition of isotope distribution patterns that were not previously discernible. The unambiguous recognition of the isotope distribution patterns may enable confident assignment of chemical formulas, in such instances. Alternatively, the recognized matches or assignments may be used adjust operation of the chromatograph, the ion source or the electrodes during generation of a second plurality of progenitor ion types and a second plurality of product ion types during a second, subsequent time range.

The product or fragment ion types may be formed by one or more of the processes of: adduction of species other than H+ to progenitor ion types, dehydration of progenitor ion types, dimerization of progenitor ion types, or collection of transfer of charge to progenitor ion types. Further, product or fragment ion types may be formed by the process of in-source fragmentation, in which an accelerating potential is applied to progenitor ions so as to cause collision induced dissociation, either within an ionization chamber, a first differentially-pumped vacuum chamber, or an ion transfer tube that fluidically couples an ionization chamber to a first vacuum chamber. Because such in-source fragmentation may fragment many or all progenitor ion types simultaneously, it is generally not possible to select a single ion for such fragmentation. However, by using methods in accordance with the present teachings, information similar to that conventionally derived by tandem mass spectrometry may be obtained from in-source fragmentation studies.

In various embodiments, a subset of the synthetic analytical peaks which do not satisfy noise reduction rules may be discarded prior to performing the cross-correlation score calculations. The discarding may comprise the steps of: comparing an area, Aⱼ, of each synthetic analytical fit peak of each respective XIC to a total area, ΣA, of the respective XIC; comparing an intensity, Iⱼ, of each synthetic analytical fit peak of each respective XIC to an average peak intensity, Iₐᵥₑ, of the respective XIC; and discarding synthetic analytical fit peaks for which (Aⱼ/ΣA)<ω or that (Iⱼ/Iₐᵥₑ)<ρ, in which ω and ρ are pre-determined constants.

In various embodiments, the step of performing a respective cross-correlation score calculation between each pair of synthetic analytical fit peaks may include calculating a peak shape correlation (PSC) between each pair (p1, p2) of synthetic analytical peak profiles. Such peak shape correlations may be calculated by an equation such as:

$$PSC ( p 1 , p 2 ) = \frac{{\sum }_{j = j min}^{j = j max} [ p 1 ( {t}_{j} ) \times p 2 ( {t}_{j } ) ]}{{\{ {\sum }_{j = j min}^{j = j max} p 1 {( {t}_{j} )}^{2} \}}^{1 \text{/} 2} {\{ {\sum }_{j = j min}^{j = j max} p 2 {( {t}_{j} )}^{2} \}}^{1 \text{/} 2}}$$

in which p1(tⱼ) and p2(tⱼ) are the values of the synthetic analytical peak profiles, p1 and p2, respectively, at each j^{th} time point and wherein j min and j max are defined lower and upper indices, respectively.

### BRIEF DESCRIPTION OF THE DRAWINGS

The above noted and various other aspects of the present invention will become apparent from the following description which is given by way of example only and with reference to the accompanying drawings, not drawn to scale, in which:

FIG. 1 is a schematic illustration of an example of a conventional mass spectrometer system;

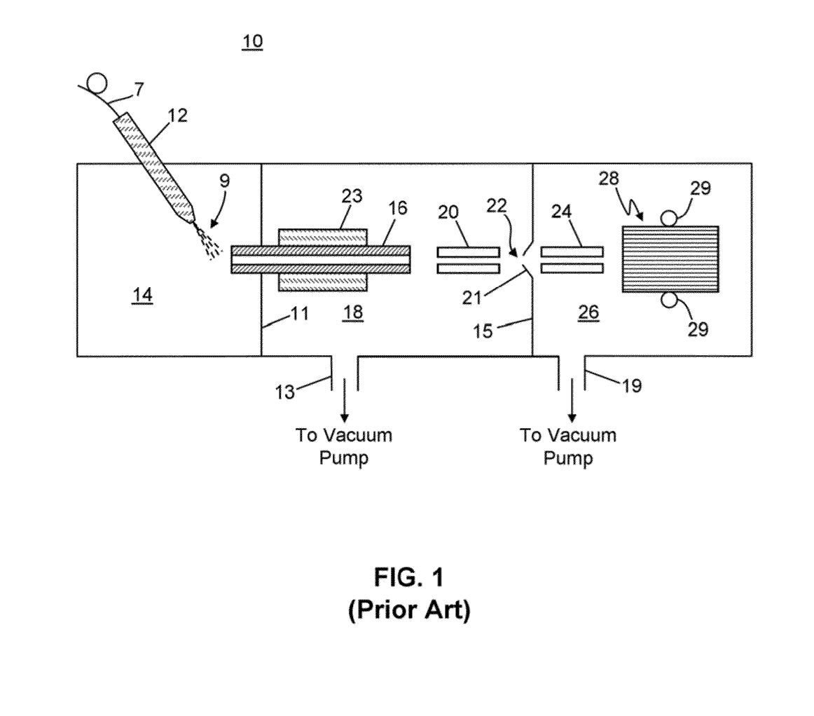

FIG. 2 is a schematic diagram of a system for generating and automatically analyzing chromatography/mass spectrometry spectra in accordance with the present teachings;

FIG. 3 is a perspective view of a three-dimensional graph of chromatography-mass spectrometry data, in which the variables are time, mass (or mass-to-charge ratio, m/z) and ion abundance;

FIG. 4A is a perspective view of a three-dimensional graph of chromatography-mass spectrometry data showing four hypothetical mass spectra of primary ions and corresponding mass spectra of derived ions and showing hypothetical extracted ion chromatograms (XICs) for several different values of mass-to-charge ratio;

FIG. 4B is a perspective view of a portion of the three-dimensional graph of FIG. 15A showing selected peaks as extracted ion chromatograms;

FIG. 4C is a perspective view of a portion of the three-dimensional graph of FIG. 15A showing selected peaks as mass scans;

FIG. 5 is a flowchart of a method for acquiring and interpreting mass spectral data in accordance with the present teachings;

FIGS. 6A-6B provide a flowchart of a method for automatically recognizing correlations between primary ions and adduct or fragment ions in accordance with the present teachings;

FIGS. 7A-7C are graphical examples of discrimination of peaks of interest from noise peaks in an ion chromatogram;

FIG. 8 is a flowchart of a method for automated spectral peak detection and quantification;

FIG. 9 is a flowchart of a method for automatically removing baseline features and estimating background noise from spectral data;

FIG. 10 is a graph of an example of the variation of the calculated area underneath a baseline-corrected spectral curve as a function of the order of polynomial used in fitting the baseline to a polynomial function;

FIG. 11 is an example of a preliminary baseline corrected spectral curve prior to fitting the end regions to exponential functions and an example of the baseline comprising exponential fit functions;

FIG. 12 is a flowchart of a method for automated spectral peak detection and quantification;

FIG. 13 a graph of a hypothetical skewed spectral peak depicting a method for obtaining three points on the spectral peak to be used in an initial estimate of skew and for preliminary peak fitting;

FIG. 14 a graph of a set of gamma distribution functions having different values of shape parameter M, illustrating a fashion by such functions may be used to synthetically fit skewed spectral peaks:

FIG. 15 is a flowchart illustrating a method for choosing between line shapes used for fitting;

FIG. 16 is a set of plots of several observed line shapes in various extracted ion chromatograms obtained from LC/MS data covering the 1.7-second elution of a single mass chromatographic peak (e.g., a total ion chromatogram peak) of a 500 nM solution of the drug Buspirone;

FIG. 17 is a schematic illustration of two peaks having differing line shapes illustrating a method of calculating a cross-correlation score as a dot product; and

FIGS. 18A-18C are examples of filtered experimentally determined mass spectra illustrating various adduct and fragment ions generated in the ion source and identified employing methods in accordance with the present teachings.

### DETAILED DESCRIPTION

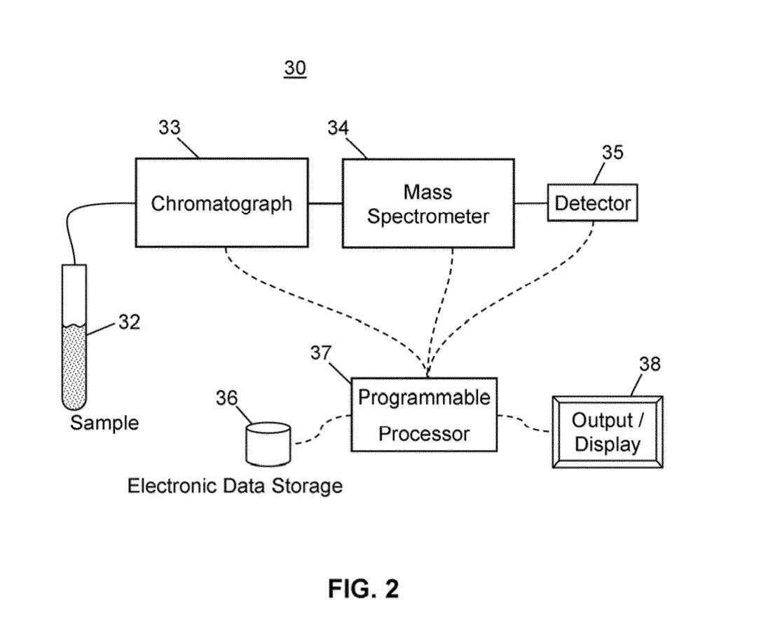

The present invention provides methods and apparatus for correlating primary ions and adduct or fragment ions formed in gas phase reactions. The automated methods and apparatus described herein do not require any user input or intervention. The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. The particular features and advantages of the invention will become more apparent with reference to the appended FIGS. 2-17, taken in conjunction with the following description.

### Section 1. General Considerations

FIG. 2 is a schematic diagram of a system 30 for generating and automatically analyzing chromatography/mass spectrometry spectra in accordance with the present teachings. A chromatograph 33, such as a liquid chromatograph, high-performance liquid chromatograph or ultra high performance liquid chromatograph or other type of chromatograph receives a sample 32 of an analyte mixture and at least partially separates the analyte mixture into individual chemical constituents, in accordance with well-known chromatographic principles. As a result, the at least partially separated chemical constituents are transferred to a mass spectrometer 34 at different respective times for mass analysis. As each chemical constituent is received by the mass spectrometer, it is ionized by an ionization source of the mass spectrometer.

The ionization source of the mass spectrometer 34 may produce a plurality of ions comprising a plurality of ion types (i.e., a plurality of primary ion types) comprising differing charges or masses from each chemical constituent. Thus, a plurality of ion types of differing mass-to-charge ratios may be produced for each chemical constituent, each such constituent eluting from the chromatograph at its own characteristic time. For purposes of this disclosure, it is assumed that the plurality of primary ion types is further augmented or modified by gas phase reactions that may occur—in either controlled or uncontrolled fashion—in a spatial region between the zone of primary ion generation and a second differentially-pumped vacuum chamber. The gas phase reactions may include adduct formation (of adduct species other than H+), dehydration reactions and losses of other stable moieties, dimerization, and collection of multiple charges. The gas phase reactions may further include fragmentation of primary ion types produced by a process of in-source fragmentation. The fragments may themselves by modified by the various types of gas-phase reactions.

The various ion types—including both primary ion species as well as species produced in gas-phase reactions—are analyzed and detected by the mass spectrometer together with its detector 35 and, as a result, appropriately identified according to their various mass-to-charge ratios. The present disclosure makes use of the terms “ion” (or “ions” in the plural) and “ion type” (or “ion types” in the plural). For purposes of this disclosure, an “ion” is considered to be a single, solitary charged particle, without implied restriction based on chemical composition, mass, charge state, mass-to-charge (m/z) ratio, etc. A plurality of such charged particles comprises a collection of “ions”. An “ion type”, as used herein, refers to a category of ions—specifically, those ions having a given monoisotopic m/z ratio—and, most generally, includes a plurality of charged particles, all having the same monoisotopic m/z ratio. This usage includes, in the same ion type, those ions for which the only difference or differences are one or more isotopic substitutions. One of ordinary skill in the mass spectrometry arts will readily know how to recognize isotopic distribution patterns and how to relate or convert such distribution patterns to monoisotopic masses.

Still referring to FIG. 2, a programmable processor 37 is electronically coupled to the detector of the mass spectrometer and receives the data produced by the detector during chromatographic/mass spectrometric analysis of the sample(s). The programmable processor may comprise a separate stand-alone computer or may simply comprise a circuit board or any other programmable logic device operated by either firmware or software. Optionally, the programmable processor may also be electronically coupled to the chromatograph and/or the mass spectrometer in order to transmit electronic control signals to one or the other of these instruments so as to control their operation. The nature of such control signals may possibly be determined in response to the data transmitted from the detector to the programmable processor or to the analysis of that data. The programmable processor may also be electronically coupled to a display or other output 38, for direct output of data or data analysis results to a user, or to electronic data storage 36.

The programmable processor shown in FIG. 2 is generally operable to, among other things: receive a mass spectrum from the chromatography/mass spectrometry apparatus; generate and evaluate a plurality of extracted ion chromatograms (XICs) representing respective mass-to-charge ratios within the mass spectrum; automatically subtract a baseline from each such XIC so as to generate a plurality of baseline-corrected XICs; automatically detect and characterize all spectral peaks occurring above a noise level in each baseline-corrected XIC; perform a cross-correlation calculation between each pair of detected peaks; and report or record information relating to the peaks, to the cross-correlations between the peaks or to possible adduct or fragmentation relationships between ions determined from the correlation calculations.

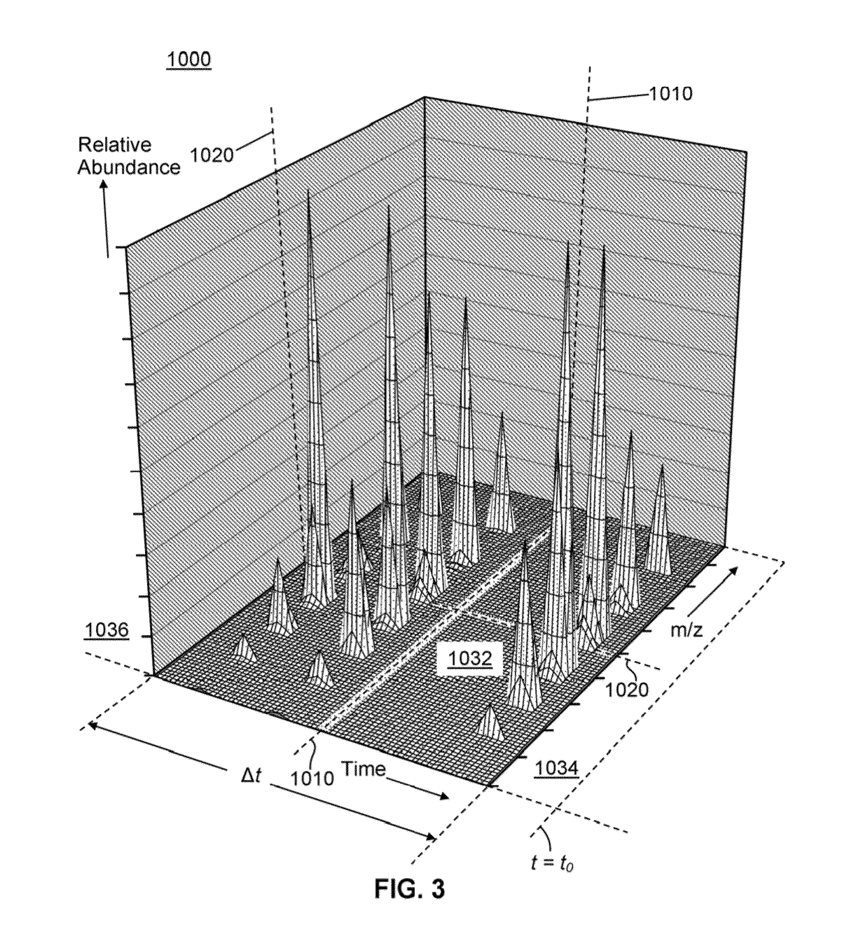

FIG. 3 is a perspective view of a three-dimensional graph of hypothetical LC/MS data. As is common in the representation of such data, the variables time and mass (or mass-to-charge ratio, m/z) are depicted on the “floor” of the perspective diagram and the variable representing ion abundance (for instance, detected ion current) is plotted in the “vertical” dimension of the graph. Thus, ion abundance is represented as a function of the other two variables, this function comprising a variably shaped surface above the “floor”. Each set of peaks dispersed and in line parallel to the m/z axis represents the various ion types produced by the ionization of a single eluting analyte (or, possibly, of fortuitously co-eluting analytes) at a restricted range of time. In a well-designed chromatographic experiment, each analyte of a mixture will elute from the column (thereby to be mass analyzed) within a particular diagnostic time range. Consequently, either a single peak or a line of mass-separated peaks, each such peak representing a particular ion produced by the eluting analyte, is expected at each elution time (or retention time) range.

For clarity, only a very small number of peaks are illustrated in FIG. 3. In practice, data obtained by a chromatography-mass spectrometry experiment may comprise a very large volume of data. A mass spectrometer may generate a complete “scan” over an entire mass range of interest in a matter of tens to hundreds of milliseconds. As a result, up to several hundred complete mass spectra may be generated every second. Further, the various analytes may elute over a time range of several minutes to several tens of minutes, depending on the complexity of the mixture under analysis and the range of retention times represented.

The data depicted in FIG. 3 may comprise an entire stored data file representing results of a prior experiment. Alternatively, the data represent a portion of a larger data set in the process of being acquired by an LC/MS instrument. For instance, the data depicted in FIG. 3 may comprise recently collected data held in temporary computer readable memory, such as a memory buffer, and corresponding to an analysis time window, Δt, upon which calculations are being formed while, at the same time, newer data is being collected. Such newer, not-yet-analyzed data is represented, in time and m/z space, by region 1034 and the data actually being collected is represented by the line t=t₀. Older data which has already been analyzed by methods of the present teachings and which has possibly been stored to a permanent computer readable medium, is represented by region 1036. With such manner of operation, methods in accordance with the present teachings are carried out in near-real-time on an apparatus used to collect the data or using a processor (such as a computer processor) closely linked to the apparatus used to collect the data.

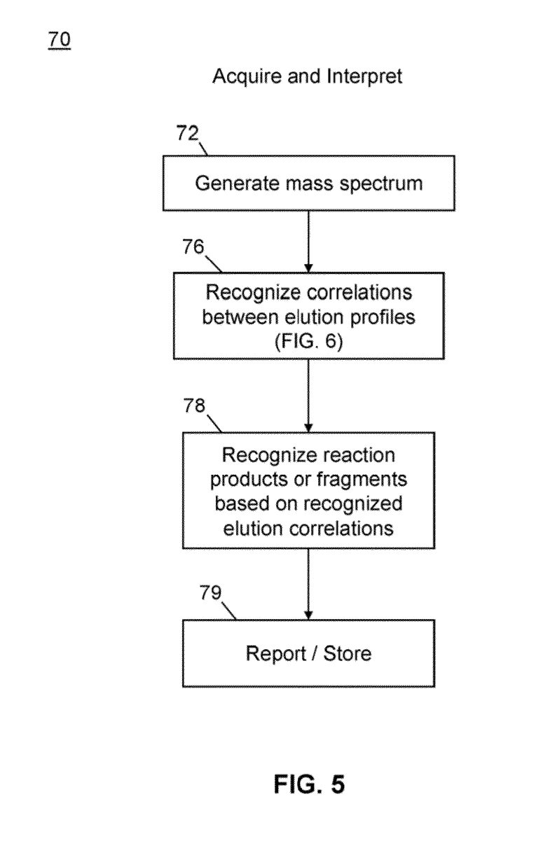

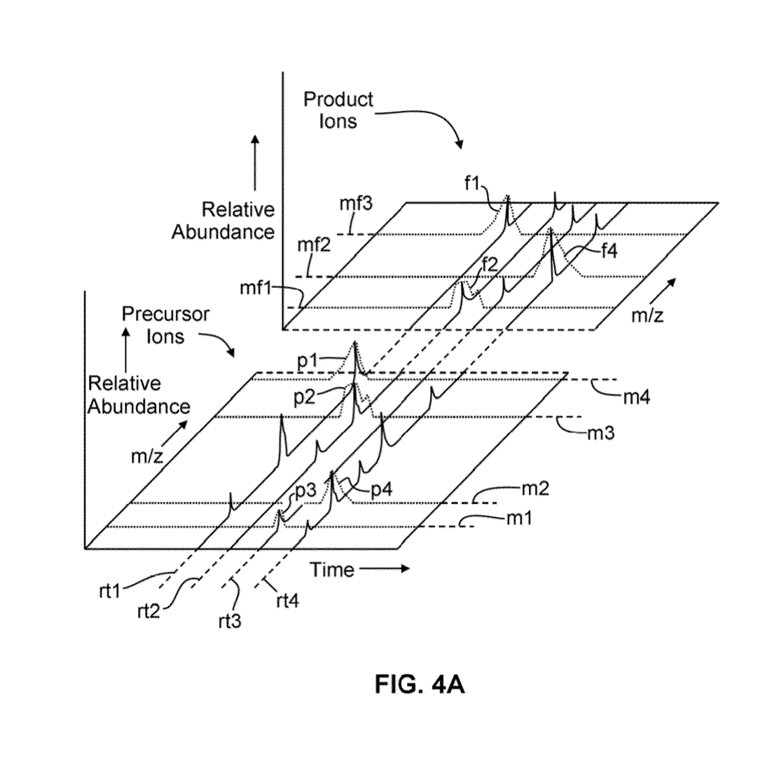

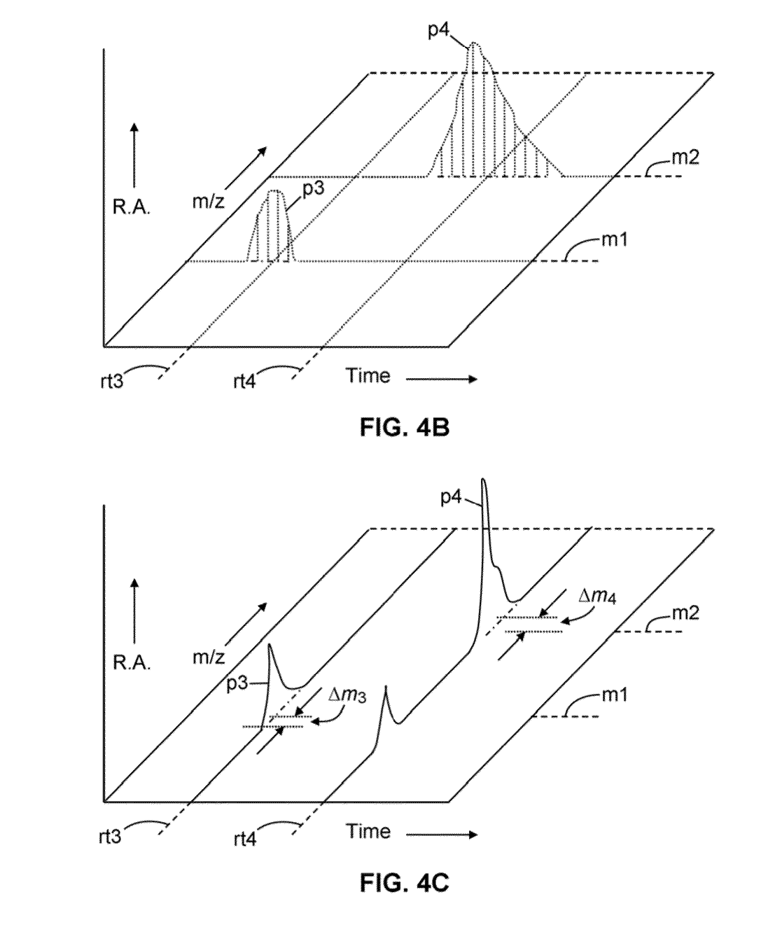

Operationally, data such as that illustrated in FIG. 3 is collected as separate mass spectra (also referred to herein as “scans”), each mass spectrum (scan) corresponding to a particular respective time point. Such mass spectra may be envisioned as residing within planes parallel to the plane indicated by the trace lines 1010 in FIG. 3 or parallel to the lines rt1, rt2, rt3 and rt4 in FIG. 4A. Once at least a portion of data has been collected, such as the data in region 1032 in FIG. 3, then the information in the data portion may be logically re-organized as extracted ion chromatograms (or, at least portions thereof). Each such XIC may be envisioned as a cross section through the data in a plane parallel to the plane indicated by trace lines 1020 in FIG. 3 or parallel to the lines m1, m2, m3, m4, mf1, mf2, and mf3 in FIG. 4A.

The XIC representation of the data is useful for understanding the methods of the present teachings. Several schematic extracted ion chromatograms are illustrated in FIG. 4A by dotted lines residing at respective mass-to-charge values indicated by sections m1, m2, m3 and m4 as well as at mass-to-charge values indicated by sections mf1, mf2 and mf3. Each XIC represents the elution profile, in time, of ions of a particular mass-to-charge range. Subsequent to execution of the methods discussed in Sections 2-3 below, each such XIC is defined by a set of synthetic peaks calculated by those methods. The hypothetical synthetic extracted ion chromatograms schematically shown in FIG. 4A illustrate elution of various ionized chemical constituents at closely-spaced times rt1, rt2, rt3 and rt4. Although illustrated as separated times, one or more of the times rt1, rt2, rt3 and rt4 could even be identical to one another, such that the various chemical constituents are co-eluting constituents. It should be noted that the mass scale (i.e., m/z scale) relating to product ion scans in FIG. 4A is not a simple extension of the mass scale relating respectively relating to precursor ion scans. In fact, the two mass scales may overlap one another but are not necessarily identical to one another.

The set of extracted ion chromatograms indicated by sections m1, m2, m3 and m4 in FIG. 4A could be algebraically summed so as to yield a reconstructed total ion chromatogram (not shown). Likewise, the synthetic peak intensities provided by the peak detection and fitting routines described in the following Section 3 could be projected onto the time sections shown at times rt1, rt2, rt3 and rt4 in order to generate reconstructed mass spectra (reconstructed “scans”). Reconstructed mass spectra are illustrated by the solid-line curves in FIG. 4A and FIG. 4C. The reconstructed scans may be generated by including all ion masses that produce a chromatographic peak at the time corresponding to the scan, lie within the linewidth of said peak, and were collected under identical scan filters. Thus, every ion present in a reconstructed scan is known to contribute to a chromatographic peak, whose apex is nearby but not necessarily at the time of the scan.

### Section 2. High-Level Methods

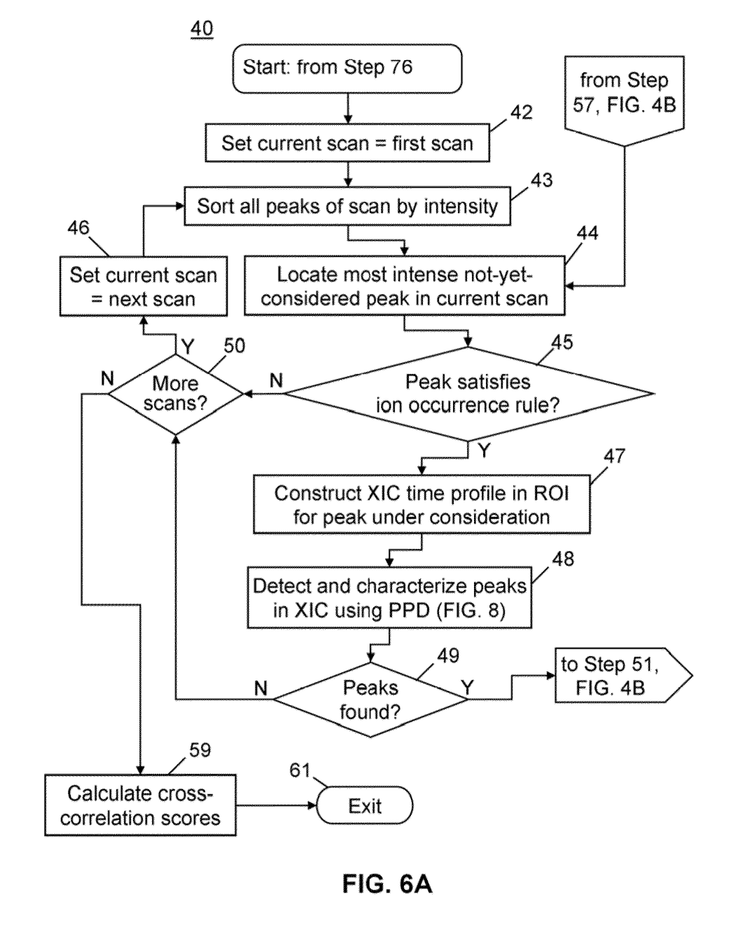

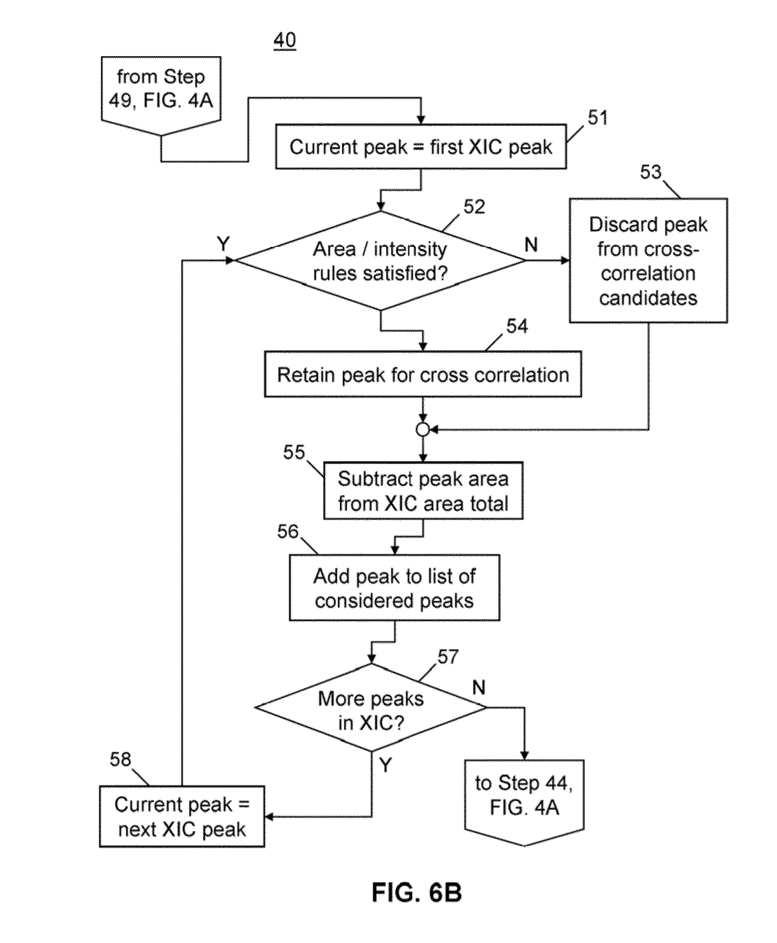

FIG. 5 is a high-level flow chart of a general method in accordance with the present teachings. The general method 70 illustrated in FIG. 5 may be considered as a method for acquiring data using a mass spectrometer system and interpreting that data, as it is acquired. In Step 72, full-scan mass spectral data is generated by the mass spectrometer system. Each data subset comprises ion abundance (or relative abundance) information as a function of time and m/z. The mass spectral data may represent a certain time increment or time range corresponding to a current region of interest (ROI) of recently collected data, such as the region 1032 of FIG. 3. In the next step, Step 76, an attempt is made to recognize correlations between elution profiles exhibited by various ions as may be represented, for example, in extracted ion chromatograms. Such correlations may be recognized, for instance, by employing the detailed steps of the method 40 (FIG. 6) discussed below. Subsequently, the Step 78 is executed, in which the recognized elution profile correlations are used to recognize sets of ion types (having respective mass-to-charge ratios), the ion types of each set related either as precursor and reaction product, as precursor and fragment, as precursor and reacted fragment (such as an adduct of a fragment), etc.

Finally, in step 79, the results are reported to a user (or stored for later use). The results may include information regarding detected peaks or other information. The reporting may be performed in numerous alternative ways—for instance via a visual display terminal, a paper printout, or, indirectly, by outputting the parameter information to a database on a storage medium for later retrieval by a user. The results may include calculated product/precursor matches, adduct/precursor matches, information regarding detected peaks or other information. The reporting step may include reporting either textual or graphical information, or both. Peak parameters, if reported, may comprise either those parameters calculated during the peak detection step or quantities calculated from those parameters and may include, for each of one or more peaks, location of peak centroid, location of point of maximum intensity, peak half-width, peak skew, peak maximum intensity, area under the peak, etc. Other parameters related to signal to noise ratio, statistical confidence in the results, goodness of fit, etc. may also be reported in step 79.

FIGS. 6A-6B present a flowchart of a method 40 for performing the Step 76 so as to automatically recognize correlations between elution profiles of ions. The method 40 diagramed in FIG. 4 is but one example. At a high- or most-general level, the method 40 may be replaced any algorithm that systematically examines the data searching for peaks to be tested by subsequent cross-correlation calculation. The calculations of method 40 may be performed on mass spectral data relating to a current region of interest (ROI)— that is, a certain time range—of recently collected data as noted above. In embodiments, the time increment corresponding to the ROI is 0.6 minutes wide, but other window widths may work equally well. These time windows represent a small portion of a typical chromatographic experiment which may run for several tens of minutes to on the order of an hour. For data dependent instrument control, a much smaller time window would probably be used. Such data dependent instrument control functions may be performed in automated fashion, wherein the results obtained by the methods herein are used to automatically control operation of the instrument at a subsequent time during the same experiment from which the data were collected. For instance, based on the results of the algorithms, a voltage may be automatically adjusted in an ion source or an acceleration potential may be adjusted with regard to in-source fragmentation operation. Such automatic instrument adjustments may be performed, for instance, so as to optimize the type or number of ions or ion fragments produced.

In step 42 of the present example (FIG. 4A), the scan to be examined (the current scan) is set to be the initial scan within the ROI. This is an initialization step for a loop in which scans are sequentially examined. In step 43, the peaks of the current scan are sorted by intensity and the ions are examined one by one, starting with the most intense (step 44). In general, all ions are examined, but for very rapid work or strong signals, a threshold may be applied and only ions with intensities above threshold examined. In the present example, step 59 (described in greater detail later in this document) is performed when all ions in all scans of the ROI have been examined. In Step 45 of this example, the occurrence of an ion is noted, and its history or time-profile is compared to a rule for ions to be considered as forming a peak. A preferred rule that is used is that the ion must occur in three contiguous scans (scans of the same type), but any rule based on ion appearance and scan number may be used. For example, a rule that the ion must appear in 3 of 5 contiguous scans might alternatively be chosen. (Ions are considered identical if they agree within the mass tolerance, and as an ion history is accumulated, any new occurrence is compared to the average value of the previous instances, not simply the previous instance.)

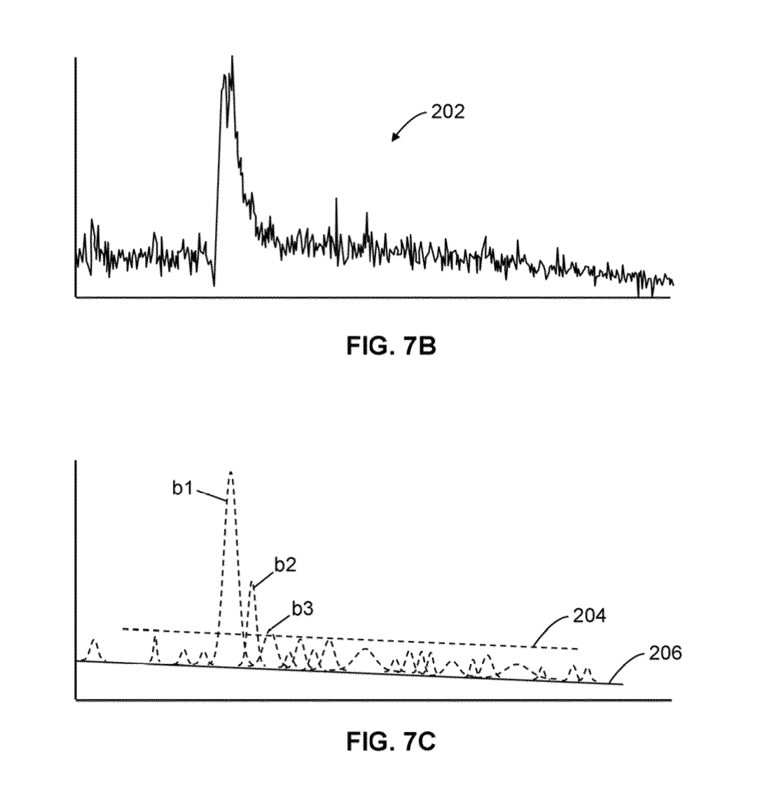

If, in step 45, the peak does not satisfy the ion occurrence rule, then, if there are more unexamined scans in the ROI (determined in step 50), the current scan is set to be the next unexamined scan (step 46) and the method returns to step 43 to begin examining the new current scan. If the ion occurrence rule (as determined in step 45) is satisfied, then an extracted ion chromatogram corresponding to the m/z range of the ion peak under consideration is constructed in step 47. It is to be noted that the terms “mass” and “mass-to-charge” ratio, as used here, actually represent a small finite range of mass-to-charge ratios. The width or “window” of the mass-to-charge range is the stated precision of the mass spectrometer instrument. The technique of Parameterless Peak Detection (PPD, see FIG. 8 and discussion thereof as well as U.S. Pat. No. 7,983,852) then attempts to find peaks in an extracted ion chromatogram (XIC) corresponding to this 0.6 minute time window in step 48. Once this particular mass has been tested for peaks in the XIC, it is not tested again until the center of the time window has increased by the window size. (So, for example, if an ion is tested for peaks when the time window is 2.0-2.6, it will not be tested again until the window is 2.6-3.2.)

Subsequent steps of the method 40 are performed using the analytical functions provided by the synthetic fitted peaks generated by PPD (or calculated peak parameters) instead of using the original data. If, in the decision step 49, no peaks are found by PPD for the mass under consideration, then, if there are remaining unexamined scans (step 50), the method returns back to step 46 and then step 43. However, if peaks are found, then the method continues to step 51 (FIG. 4B) in which the first of possibly several peaks in the XIC is set for initial consideration. In the next step 52, for each peak found by PPD, additional rules of large relative area and high relative intensity (described in further detail in the next paragraph) are applied. Peaks that fail these tests are discarded (step 53), whereas those that pass are accepted and retained (step 54) for further processing by cross-correlation score calculations (such correlation scores are calculated in step 59). Regardless of whether or not a peak is accepted, after each peak is considered, the peak area of the peak is subtracted (step 55) from the total area used in the relative area criterion in subsequent iterations of step 52. Also (step 56) the peak is added to a list of peaks within the ROI that have been examined, to prevent possible duplicate consideration of a single peak.

The step 52 of the method 40 is now discussed in more detail. In step 52, the area of, Aⱼ, of the peak currently under consideration (the j^{th} peak) is noted. Also, the total area (ΣA) under the curve the fitted chromatogram and the average peak height (Iₐᵥₑ) of any remaining peaks in the fitted chromatogram are calculated. The area ΣA is the area of the data remaining after any previous peaks have been detected and removed. The step 52 compares the area, A, of the most recently found peak to the total area (ΣA). Also, this step compares the peak maximum intensity, Iⱼ, of the most recently found peak is compared to Iₐᵥₑ. If it is found either that (Aⱼ/ΣA)<ω or that (Iⱼ/Iₐᵥₑ)<ρ, where ω and ρ are pre-determined constants, then the execution of the method 40 branches to step 53 in which the peak is removed from a list of peaks to be considered in—and is thus eliminated from consideration in—the subsequent cross-correlation score calculation step.

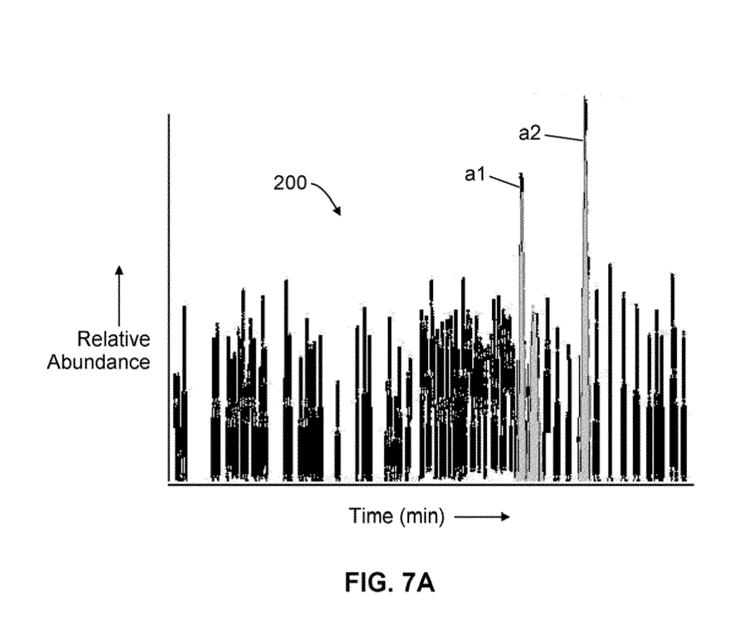

The removal of certain peaks in this fashion renders the fitted peak set consistent with the expectations that, within an XIC, each actual peak of interest should comprise a significant peak area, relative to the total peak area and should comprise a vertex intensity that is significantly greater than the local average intensity. FIGS. 7A-7C schematically illustrate this concept. For instance, after peak discrimination in step 52 (FIG. 6B), fitted peaks corresponding to data peaks a1 and a2 in of the XIC 200 in FIG. 7A may, in some embodiments, not be retained in the list of peaks to be tested by cross correlation as a result of their relatively smaller peak areas in relation to the total area above the baseline. In various embodiments, the retention of peaks may be determined based on statistical considerations—such as correlation statistics between different data files—or possibly some other criteria related to relative peak areas. Numerous fitted peaks in FIG. 7C, which represent a fit to the XIC 202 of FIG. 7B, are eliminated by a different criterion. For example, all fitted peaks in FIG. 7C that do not extend above line 204 may be eliminated because their peak heights do not meet a peak height criterion, even though the areas of several of them are not insignificant. In the illustrated example, line 206 is a baseline and line 204 is a line offset from the baseline such that the vertical distance between the two lines represents a minimum peak height for acceptance. Thus, in this case, only peaks b1, b2 and b3 are retained. In various embodiments, the retention of peaks may be determined based on statistical considerations or some other criteria related to relative peak heights.

Returning to the discussion of the method 40 (FIG. 6B), it may be noted that if the decision step 57 determines that more peaks exist in the XIC under consideration, then the method branches to step 58 in which the next peak is set for consideration and then back to step 52. If, however, it is determined that no additional peaks remain the XIC, then execution goes back to step 44 (FIG. 6A) so as to continue examining additional peaks (if any) in the current scan. The above-described sequence continues until all peaks in all scans have been examined and, consequently, all peaks to be used for matching have been identified. Subsequently, in Step 59, the cross correlation for each retained XIC peak is calculated with respect to every other mass that formed an XIC peak in the region of interest time range. Each detected peak is considered, through a cross-correlation calculation, against every other detected peak in order to match ion types and to recognize relationships between ion types having similar elution profiles. The details of the calculations are presented in a subsequent section herein. The method 40 terminates at step 61.

### Section 3. Parameterless Peak Detection in One Independent Variable

The method 40 diagrammed in FIGS. 6A-6B provides a high-level overview of generating automated correlations between the elution profiles of the various ion types. However, to fully understand and appreciate the features of the invention, it is necessary to significantly more detailed discussion of the step 48 of method 40 as well as additional procedures subsumed therein. The step 48 includes detecting and locating peaks in various extracted-ion-chromatogram (XIC) representations of the mass spectral data and may itself be regarded as a particular method, which is shown in flowchart form in FIG. 8. Since each XIC includes only the single independent variable of time (e.g., Retention Time), this section is thus directed to detection of peaks in data that includes only one independent variable. Much of the discussion in the present section is adapted from the discussion in the aforementioned U.S. Pat. No. 7,983,852.

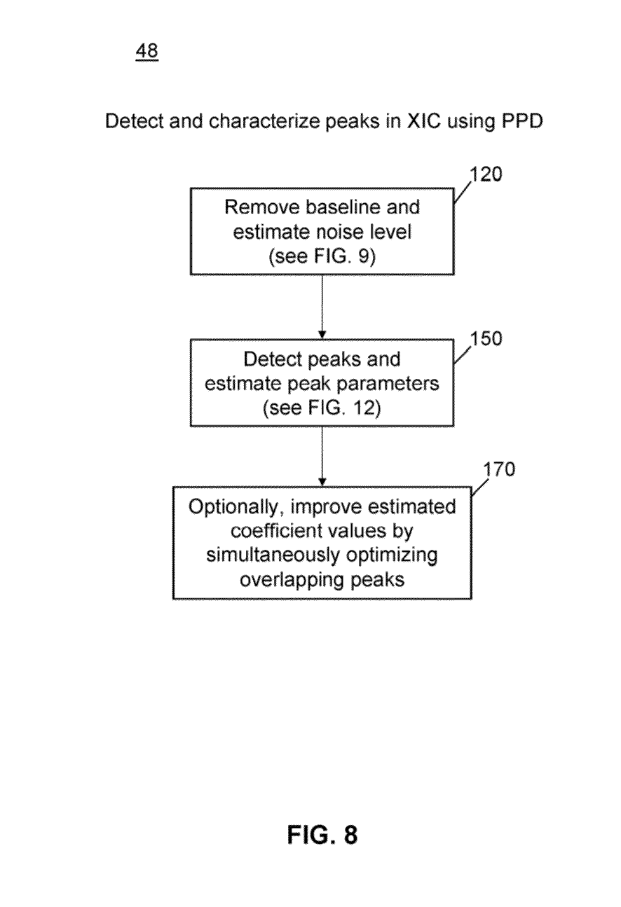

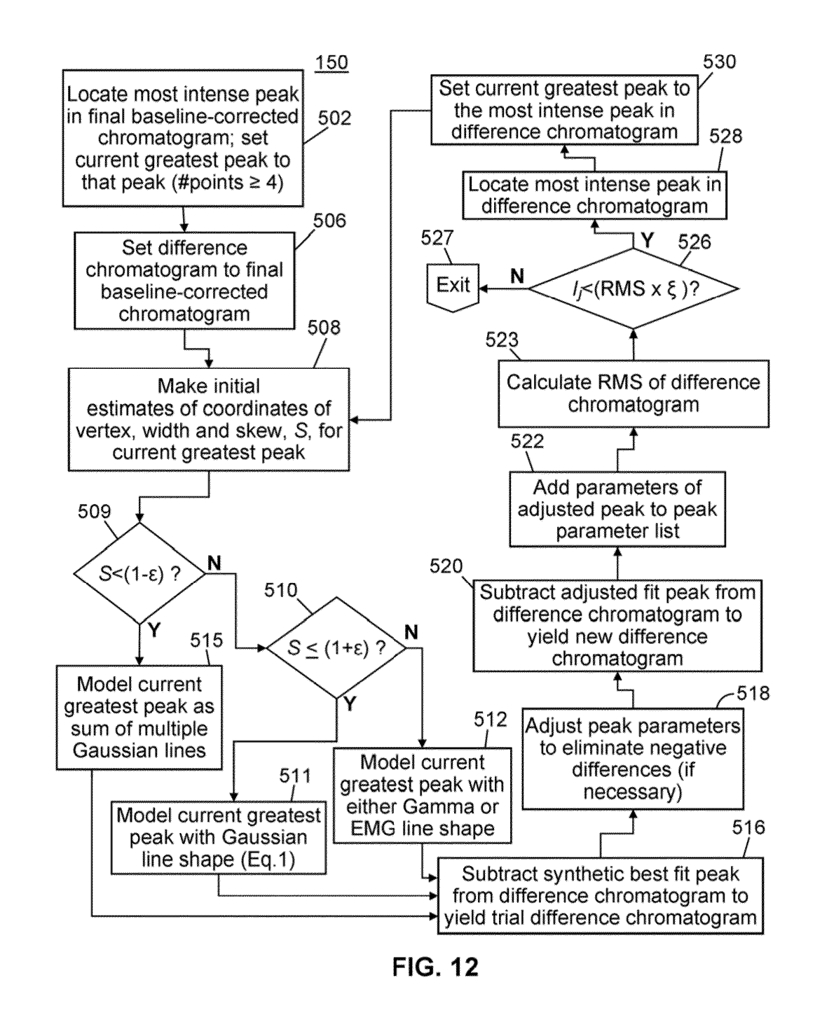

The various sub-procedures or sub-methods in the method 48 may be grouped into three basic stages of data processing, each stage possibly comprising several steps as illustrated in FIG. 8. The first step, step 120, of the method 48 is a preprocessing stage in which baseline features may be removed from the received chromatogram and in which a level of random “noise” of the chromatogram may be estimated, this step being described in greater detail in subsequent FIG. 9. The next step 150, which is described in greater detail in subsequent FIG. 12, is the generation of an initial estimate of the parameters of synthetic peaks, each of which models a positive spectral feature of the baseline corrected chromatogram. Such parameters may relate, for instance, to peak center, width, skew and area of modeled peaks, either in preliminary or intermediate form. The subsequent optional step 170 includes refinement of fit parameters of synthetic peaks determined in the preceding step 150 in order to improve the fit of the peaks, taken as a set, to the baseline corrected chromatogram. The need for such refinement may depend on the degree of complexity or accuracy employed in the execution of modeling in step 150.

The term “model” and its derivatives, as used herein, may refer to either statistically finding a best fit synthetic peak or, alternatively, to calculating a synthetic peak that exactly passes through a limited number of given points. The term “fit” and its derivatives refer to statistical fitting so as to find a best-fit (possibly within certain restrictions) synthetic peak such as is commonly done by least squares analysis. Note that the method of least squares (minimizing the chi-squared metric) is the maximum likelihood solution tfor additive white Gaussian noise. More detailed discussion of individual method steps and alternative methods is provided in the following discussion and associated figures.

### 3.1. Baseline Detection

A feature of a first stage of the method 48 (FIG. 8) takes note of the concept that (disregarding, for the moment, any chemical or electronic noise) a spectroscopic signal generally consists of signal plus baseline. If one can subtract the baseline correctly, everything that remains must be signal, and should be fitted to some sort of data peak. Thus, the first step 120 comprises determining a correct baseline and removing it from the signal. Sub-steps may include applying a polynomial curve as the baseline curve, and measuring the residual (the difference between the chromatographic data and the computed baseline) as a function of polynomial order. For instance, FIG. 9 illustrates a flowchart of a method 120 for automatically removing baseline features from spectral data in accordance with some possible implementations. The method 120 illustrated in FIG. 9 repeatedly fits a polynomial function of order n to the baseline, subtracts the best fit polynomial function from the chromatogram so as to provide a current baseline-corrected chromatogram, evaluates the quality of the fit, as measured by the remaining area, A(n), under the current baseline-corrected curve, and proceeds until A(n) changes, from one value of polynomial order to the next, by less than some pre-defined percentage of its original value.

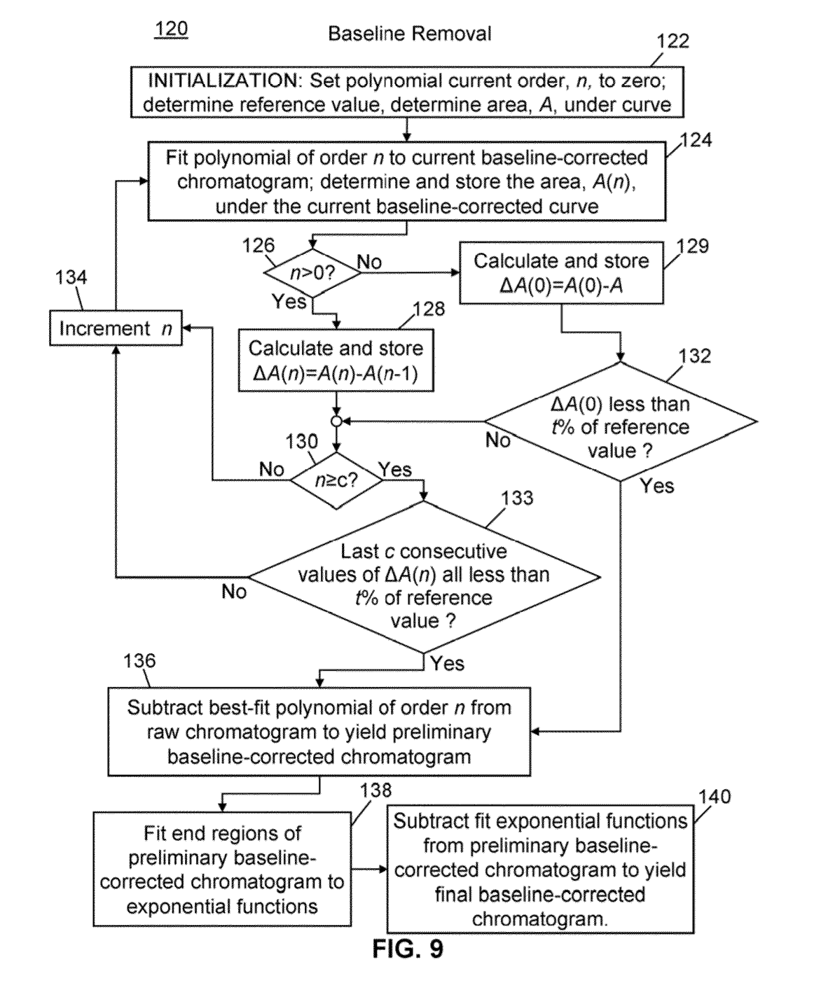

FIG. 10 is an exemplary graph 80 of the variation of the calculated area underneath a baseline-corrected chromatogram curve (not necessarily drawn to scale) as a function of increasing order of the polynomial used in fitting the baseline. FIG. 10 shows that the area initially decreases rapidly as the order of the best fit polynomial increases. This function will go from some positive value at order zero, to a value of zero at some high polynomial order. However, as may be observed from FIG. 10, after most of the baseline curvature has been fit, the area function attains a plateau region 82 for which the area, A, under the curve changes, between polynomial orders, by some relatively small amount (for instance 5% of its initial value). At this point, the polynomial-fitting portion of the baseline determination routine may be terminated. Any further incrementing of the order, n, of the baseline-fitting polynomial so as to further decrease the area under the curve, beyond that associated with the plateau region 82 may not only be un-necessary but may also be counter-productive, since actual peaks may be incorrectly fit as if they are part of the baseline (region 85).

To locate the plateau region 82 as indicated in FIG. 10, methods according to various implementations may repeatedly compute an area A(n) under the current baseline-corrected chromatogram for sequential values of polynomial order, n. Each time that n is incremented, the resulting change of the baseline-corrected area, ΔA(n), is determined. This process is continued until a region is found in which the change of the baseline-corrected area, ΔA(n), is less than some pre-defined percentage (for instance, 5%) of a certain reference value determined from the chromatogram. The stopping criterion may further require that the change of A(n) remains at or below such a level for a certain number c (for instance, four) of sequential iterations. The reference value may comprise, for instance, the area, A, under the curve of the original raw chromatogram. Alternatively, the reference value may comprise some other quantity calculated from the spectral values.

Once it is found that ΔA(n) less than the pre-defined percentage of the reference value, possibly for c iterations, then one of the most recent polynomial orders (for instance, the lowest order of the previous four) is chosen as the correct polynomial order. The subtraction of the polynomial with the chosen order yields a preliminary baseline corrected chromatogram, which may perhaps be subsequently finalized by subtracting exponential functions that are fit to the end regions.

Although the above discussion regarding baseline removal is directed to the general case, it should be noted that the mere construction of an XIC representation eliminates signal from most interfering ions. Thus, the magnitudes of baseline offset and baseline curvature are generally minimal for such data representations. Thus, when a baseline-correction procedure is performed for an XIC, as in the current teachings, the change in the calculated area under the curve may be below the reference value after the first polynomial fit (n=0, where n is the polynomial order). In such cases, it may not be necessary to continue the baseline fitting procedure for all c iterations described above. Instead, the baseline may be taken as being equal to a constant value (perhaps zero) or a simple line under the curve.

Returning, now, to the discussion of method 120 shown in FIG. 9, it is noted that the first step 122 comprises loop initialization step of setting the order, n, of the baseline fitting polynomial to an initial value of zero and determining a reference value to be used, in a later step 132, for determining when the fitting polynomial provides an adequate fit to the baseline. The reference value may simply be the area under the curve of the raw chromatogram. Alternatively, the reference value may be some other measure determined from the chromatogram.

From step 122, the method 120 proceeds to a step 124, which is the first step in a loop. The step 124 comprises fitting a polynomial of the current order (that is, determining the best fit polynomial of the current order) to the raw chromatogram by the well-known technique of minimization of a sum of squared residuals (SSR). The area under the curve of the baseline-corrected chromatogram is calculated as a function of n, ΔA(n). The value of ΔA(n) is stored at each iteration for comparison with the results of other iterations.

From step 124, the method 120 proceeds to a decision step 126 in which, if the current polynomial order n is greater than zero, then execution of the method is directed to step 12S in order to calculate and store the difference ΔA(n), between the area under the chromatogram determined with the present polynomial fit relative to the area value determined in the iteration just prior. In other words, ΔA(n)=A(n)−A(n−1). The value of ΔA(n) may be taken a measure of the improvement in baseline fit as the order of the baseline fitting polynomial is incremented to n (see FIG. 10).

If, in step 126, it is determined that n=0 (in other words, only a single baseline fit has been determined with the baseline taken as a constant value), then step 129 is executed instead of step 128. In step 129, the difference, ΔA(0), between the area under the baseline-corrected chromatogram and the area under the curve, A, of the non-baseline-corrected chromatogram is calculated. With regard to extracted ion chromatograms (XICs), most of the interfering circumstances or conditions that cause non-zero, sloping or curved baselines are eliminated by the XIC construction technique. Therefore, XIC baselines may often be flat, to a very close approximation. Accordingly, a zero-order polynomial may comprise an adequate baseline approximation for extracted ion chromatograms (or other chromatograms that are free from interferences). To test for a flat baseline, step 132 compares the value of ΔA(0), as calculated in step 129 to the reference value. If it is determined that ΔA(0) is less than some pre-defined percentage, t %, of the reference value, then the polynomial portion of baseline correction is completed and the method branches to step 136, in which the calculated polynomial of order n=0 is subtracted from the raw chromatogram to yield a preliminary baseline-corrected chromatogram.

Step 130 of the method 120 is executed either if n>0 or n=0 and ΔA(0) is greater than or equal to t % of the reference value. If, in step 130, it is determined that n>c, where the pre-determined positive integer c is the number of sequential iterations required to recognize the plateau region 82 as illustrated in FIG. 10, then the method branches to step 132, in which the last c values of ΔA(n) are compared to the reference value. However, in the alternative situation (n<c), there are necessarily fewer than c recorded values of ΔA(n), and step 132 is bypassed, with execution being directed to step 134, in which the integer n is incremented by one.

The iterative loop defined by all steps from step 124 through step 133, inclusive, proceeds until ΔA(n) changes, from one iteration to the next (that is to say, from one polynomial order to the next) by less than t % of the reference value for c consecutive iterations. At this point, the polynomial portion of baseline correction is completed and the method branches to step 136, in which the final polynomial order is set and a polynomial of such order is subtracted from the raw chromatogram to yield a preliminary baseline-corrected chromatogram.

The above discussion provides but one example of a method for baseline correction of a chromatogram. However, other baseline correction methods are available and might be alternatively employed in conjunction with the present teachings. For example, a baseline signal might be computed from a moving median value of the actual signal within certain moving “windows” of the data using a median filter technique. For example, see U.S. Pat. No. 6,112,161 in the names of inventors Dryden and Quimby, which is incorporated herein by reference in its entirety. In this case, the plot of FIG. 10 looks similar to that shown in the accompanying drawings, except that the residual area is plotted as a function of the width, m, of the moving median filter window as the width decreases from Nₚ to 1 in going from left to right across the plot, where Nₚ is the total number of data points in the chromatogram.

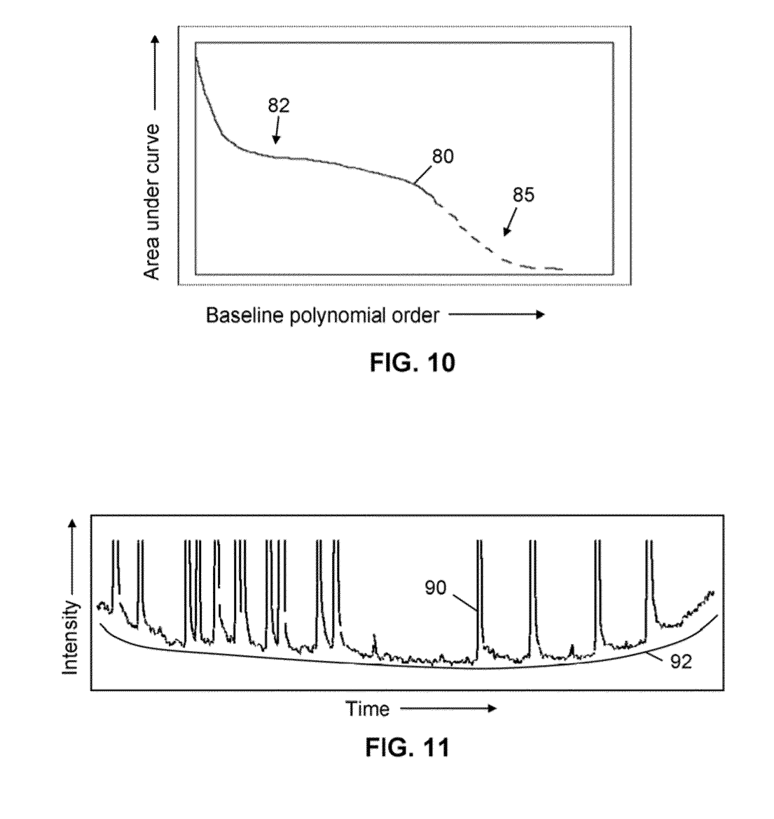

The polynomial baseline correction is referred to as “preliminary” since, in a general case, edge effects may cause the polynomial baseline fit to be inadequate at the ends of the data, even though the central region of the data may be well fit. FIG. 11 shows an example of such a preliminary baseline corrected chromatogram 90. The residual baseline curvature within the end regions (for instance, the leftmost and rightmost 20% of the chromatogram) of the chromatogram 90 are well fit by a sum of exponential functions (one for each end region), the sum of which is shown in FIG. 11 as curve 92. Either a normal or an inverted (negated) exponential function may be employed, depending on whether the data deviates from zero in the positive or negative direction. This correction may be attempted at one or both ends of the chromatogram. Thus, the method 120 proceeds to step 138 which comprises least squares fitting of the end region baselines to exponential functions, and then to step 140 which comprises subtraction of these functions from the preliminary baseline-corrected chromatogram to yield the final baseline corrected chromatogram. These steps yield a final baseline-corrected chromatogram. Although this discussion regarding baseline edge-effect curvature is directed to the general case, it should be noted that the mere construction of an XIC representation eliminates signal from most interfering ions. Thus, the magnitude of baseline curvature is generally minimal for such data representations.

### 3.2. Peak Detection

At this point, after the application of the steps outlined above, the baseline is fully removed from the data and the features that remain within the chromatogram above the noise level may be assumed to be analyte signals. The methods described in FIG. 12 locate the most intense region of the data, fit it to one of several peak shapes, remove that theoretical peak shape from the experimental data, and then continue to repeat this process until there are no remaining data peaks with a signal-to-noise ratio (SNR) greater than some pre-determined value, s, greater than or equal to unity. The steps of this process are illustrated in detail in FIG. 12 as method 150 and also shown in FIG. 8 as step 150. The pre-defined value, s, may be chosen so as to limit the number of false positive peaks. For instance, if the RMS level of Rayleigh-distributed noise is sigma, then a peak detection threshold, s, of 3 sigma leads to a false detection rate of about 1%.

The method 150, as shown in FIG. 12 is an iterative process comprising initialization steps 502 and 506 and loop steps 508-530 (including loop exit decision step 526) and termination step 527. A new respective peak is located and modeled during each iteration of the loop defined by the sequence of steps 508-530.

The first step 502 of method 150 comprises locating the most intense peak in the final baseline-corrected chromatogram and setting a program variable, current greatest peak, to the peak so located. It is to be kept in mind that, as used in this discussion, the acts of locating a peak or chromatogram, setting or defining a peak or chromatogram, performing algebraic operations on a peak or chromatogram, etc. implicitly involve either point-wise operations on sets of data points or involve operations on functional representations of sets of data points. Thus, for instance, the operation of locating the most intense peak in step 502 involves locating all points in the vicinity of the most intense point that are above a presumed noise level, under the proviso that the total number of points defining a peak must be greater than or equal to four. Also, the operation of “setting” a program variable, current greatest peak, comprises storing the data of the most intense peak as an array of data points.

From step 502, the method 150 proceeds to second initialization step 506 in which another program variable, “difference chromatogram” is set to be equal to the final baseline-corrected chromatogram (see step 140 of method 120, FIG. 9). The difference chromatogram is a program variable that is updated during each iteration of the loop steps in method 150 so as to keep track of the chromatogram resulting from subtraction of all prior-fitted peaks from the final baseline-corrected chromatogram. As discussed later in this document, the difference chromatogram is used to determine when the loop is exited under the assumption that, once all peaks have been located and modeled, the difference chromatogram will consist only of “noise”.

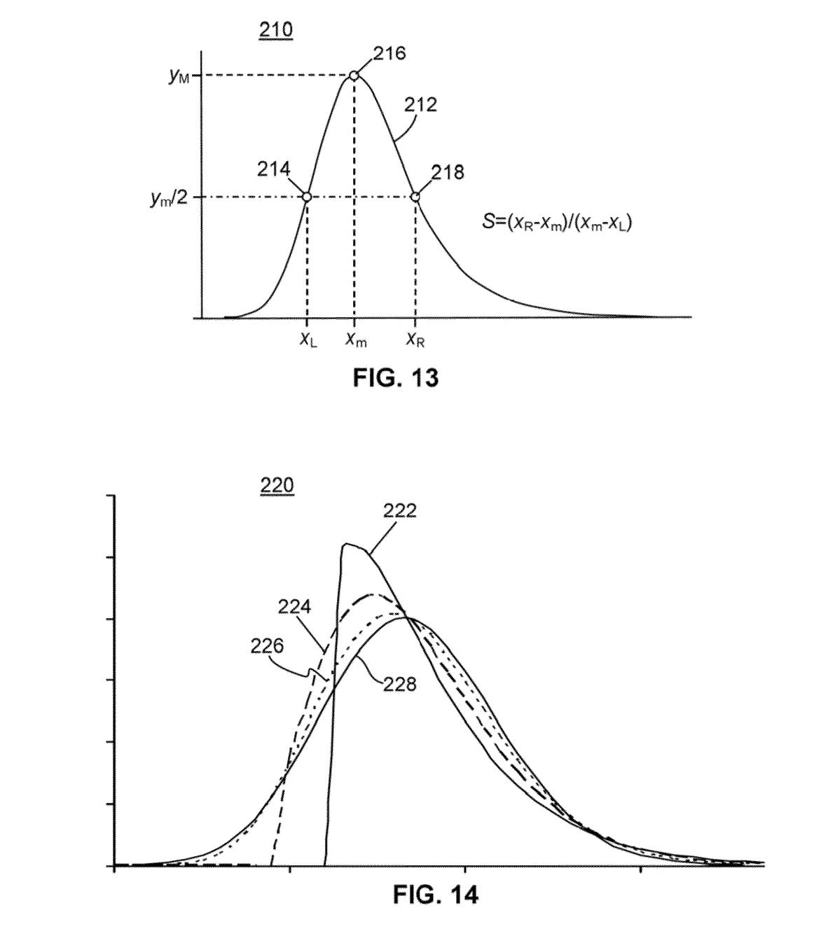

Subsequently, the method 150 enters a loop at step 508, in which initial estimates are made of the coordinates of the peak maximum point and of the left and right half-height points for the current greatest peak and in which peak skew, S is calculated. One method of estimating these co-ordinates is schematically illustrated in FIG. 13. Letting curve 212 of FIG. 13 represent the current greatest peak, then the co-ordinates of the peak maximum point 216, left half-height point 214 and right half-height point 218 are, respectively, (xₘ, yₘ), (x_{L}, yₘ/2) and (x_{R}, yₘ/2). The peak skew, S, is then defined as: S=(x_{R}−xₘ)/(xₘ−x_{L}).

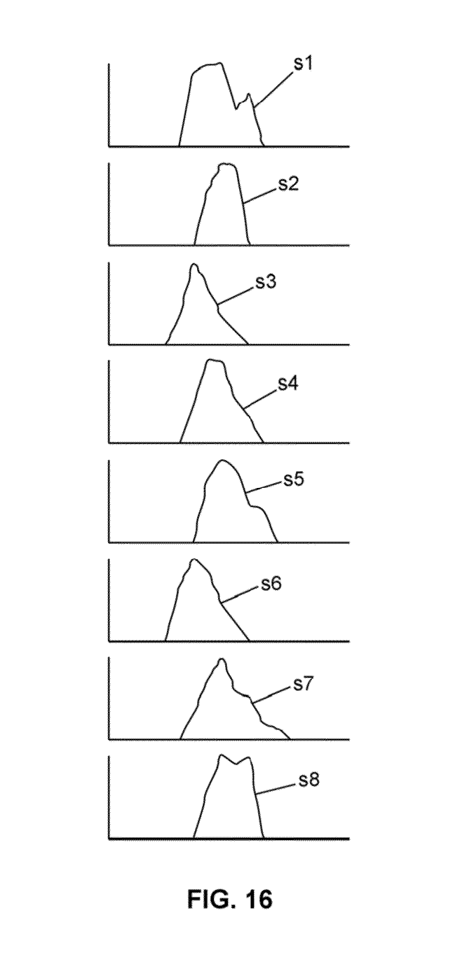

In steps 509 and 510, the peak skew, S, may be used to determine a particular form (or shape) of synthetic curve (in particular, a distribution function) that will be subsequently used to model the current greatest peak. Thus, in step 509, if S<(1−ε), where ε is some pre-defined positive number, such as, for instance, ε=0.05, then the method 150 branches to step 515 in which the current greatest peak is modeled as a sum of two or more Gaussian distribution functions (in other words, two Gaussian lines). Otherwise, in step 510, if S≦(1+ε), then the method 150 branches to step 511 in which a (single) Gaussian distribution function is used as the model peak form with regard to the current greatest peak. Otherwise, the method 150 branches to step 512, in which either a gamma distribution function or an exponentially modified Gaussian (EMG) or some other form of distribution function is used as the model peak form. Alternatively, the current greatest peak could be modeled as a sum of two or more Gaussian distribution functions in step 512. A non-linear optimization method such as the Marquardt-Levenberg Algorithm (MLA) or, alternatively, the Newton-Raphson algorithm may be used to determine the best fit using any particular line shape. After either step 511, step 512 or step 515, the synthetic peak resulting from the modeling of the current greatest peak is removed from the chromatogram data (that is, subtracted from the current version of the “difference chromatogram”) so as to yield a “trial difference chromatogram” in step 516. Additional details of the gamma and EMG distribution functions and a method of choosing between them are discussed in greater detail, partially with reference to FIG. 15, later in this document.

Occasionally, the synthetic curve representing the statistical overall best-fit to a given spectral peak will lie above the actual peak data within certain regions of the peak. Subtraction of the synthetic best fit curve from the data will then necessarily introduce a “negative” peak artifact into the difference chromatogram at those regions. Such artifacts result purely from the statistical nature of the fitting process and, once introduced into the difference chromatogram, can never be subtracted by removing further positive peaks. However, physical constraints generally require that all peaks should be positive features. Therefore, an optional adjustment step is provided as step 518 in which the synthetic peak parameters are adjusted so as to minimize or eliminate such artifacts.

In step 518 (FIG. 12), the solution space may be explored for other fitted peaks that have comparable squared differences but result in residual positive data. A solution of this type is selected over a solution that gives negative residual data. Specifically, the solution space may be incrementally walked so as to systematically adjust and constrain the width of the synthetic peak at each of a set of values between 50% and 150% of the width determined in the original unconstrained least squares fit. After each such incremental change in width, the width is constrained at the new value and a new least squared fit is executed under the width constraint. The positive residual (the average difference between the current difference chromatogram and the synthetic peak function) and chi-squared are calculated and temporarily stored during or after each such constrained fit. As long as chi-squared doesn't grow beyond a certain multiple of its initial value, for instance 3-times its initial value, the search continues until the positive residual decreases to below a certain limit, or until the limit of peak width variation is reached. This procedure results in an adjusted synthetic fit peak which, in step 520, is subtracted from the prior version of the difference chromatogram so as to yield a new version of the difference chromatogram (essentially, with the peak removed). In step 522, information about the most recently adjusted synthetic peak, such as parameters related to peak form, center, width, shape, skew, height and/or area are stored.

In step 523, the root-of-the-mean squared values (root-mean-square or RMS) of the difference chromatogram is calculated. The ratio of this RMS value to the intensity of the most recently synthesized peak may be taken as a measure of the signal-to-noise (SNR) ratio of any possibly remaining peaks. As peaks continue to be removed (that is, as synthetic fit peaks are subtracted in each iteration of the loop), the RMS value of the difference chromatogram approaches the RMS value of the noise.

Step 526 is entered from step 523. In step 526, as each tentative peak is found, its maximum intensity, I, is compared to the current RMS value, and if I<(RMS×ξ) where ξ is a certain pre-defined noise threshold value, greater than or equal to unity, then further peak detection is terminated. Thus, the loop termination decision step 526 utilizes such a comparison to determine if any peaks of significant intensity remain distinguishable above the system noise. If there are no remaining significant peaks present in the difference chromatogram, then the method 150 branches to the final termination step 527. However, if data peaks are still present in the residual chromatogram, the calculated RMS value will be larger than is appropriate for random noise and at least one more peak must be fitted and removed from the residual chromatogram. In this situation, the method 150 branches to step 528 in which the most intense peak in the current difference chromatogram is located and then to step 530 in which the program variable, current greatest peak, is set to the most intense peak located in step 528. The method then loops back to step 508, as indicated in FIG. 12.

Methods as described herein (e.g., method 150) may employ a library of peak shapes containing at least four curves (and possibly others) to model observed peaks: a Gaussian for peaks that are nearly symmetric; a sum of two Gaussians for peaks that have a leading edge (negative skewness); and either an exponentially modified Gaussian or a Gamma distribution function for peaks that have a tailing edge (positive skewness). The modeling of spectral peaks with Gaussian line shapes is well known and will not be described in great detail here. In brief, a Gaussian functional form may be employed that utilizes exactly three parameters for its complete description, these parameters usually being taken as area A, mean μ and variance σ² in the defining equation:

$$I ( x ; A , μ , {σ}^{2} ) = \frac{A}{σ \sqrt{2 π}} exp ( - \frac{{( x - μ )}^{2}}{2 {σ}^{2}} ) . \qquad Eq . 1$$

in which x is the variable of spectral dispersion (generally the independent variable or abscissa of an experiment or spectral plot) such as wavelength, frequency, or time and I is the spectral ordinate or measured or dependent variable, possibly dimensionless, such as intensity, counts, absorbance, detector current, voltage, etc. Note that a normalized Gaussian distribution (having a cumulative area of unity and only two parameters—mean and variance) would model, for instance, the probability density of the elution time of a single molecule. In the three-parameter model given in Eq. 1, the scale factor A may be taken as the number of analyte molecules contributing to a peak multiplied by a response factor.

As is known, the functional form of Eq. 1 produces a symmetric line shape (skew, S, equal to unity) and, thus, step 511 in the method 150 (FIG. 12) utilizes a Gaussian line shape when the estimated peak skew is in the vicinity of unity, that is when (1−ε)≦S≦(1+ε) for some positive quantity ε. In the illustration shown in FIG. 12, the quantity ε is taken as 0.05, but it could be any other pre-defined positive quantity. A statistical fit may performed within a range of data points established by a pre-defined criterion. For instance, the number of data points to be used in the fit may be calculated by starting with a pre-set number of points, such as 12 points and then adjusting, either increasing or decreasing, the total number of data points based on an initial estimated peak width. Preferably, downward adjustment of the number of points to be used in the fit does not proceed to less than a certain minimum number of points, such as, for instance, five points.

Alternatively, the fit may be mathematically anchored to the three points shown in FIG. 13. Alternatively, the range of the fit may be defined as all points of the peak occurring above the noise threshold. Still further alternatively, the range may be defined via some criterion based on the intensities of the points or their intensities relative to the maximum point 216, or even on criterion based wholly or in part on calculation time. Such choices will depend on the particular implementation of the method, the relative requirements for calculation speed versus accuracy, etc.

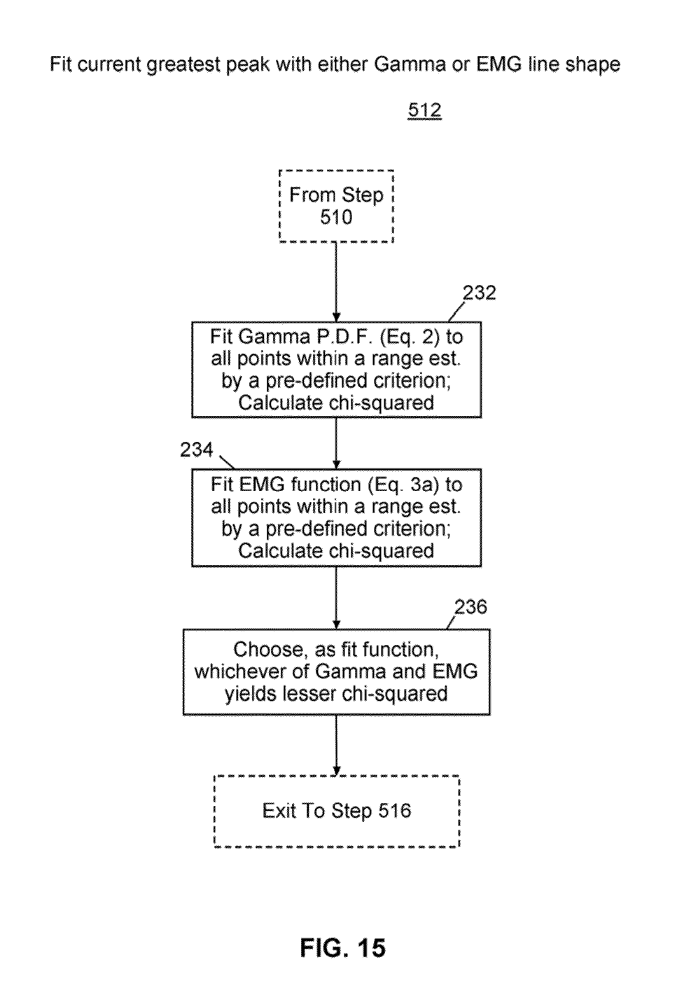

If S>(1+ε), then the data peak is skewed so as to have an elongated tail on the right-hand side. This type of peak may be well modeled using either a line shape based on either the Gamma distribution function or on an exponentially modified Gaussian (EMG) distribution function. Examples of peaks that are skewed in this fashion (all of which are synthetically derived Gamma distributions) are shown in FIG. 14. If the peaks in FIG. 14 are taken to be chromatograms, then the abscissa in each case is in the units of time, increasing towards the right.

The general form of the Gamma distribution function, as used herein, is given by:

$$I ( x ; A , {x}_{0} , M , r ) = A \frac{{{r}^{M} ( x - {x}_{0} )}^{M - 1} {e}^{- r ( x - {x}_{0} )}}{Γ ( M )} x \geq {x}_{0} \qquad Eq . 2$$

in which the dependent and independent variables are x and I, respectively, as previously defined, Γ(M) is the Gamma function, defined by

$$Γ ( M ) = {\int }_{0}^{∞} {u}^{M - 1} {e}^{- u} d u$$

and are A, x₀, M and r are parameters, the values of which are calculated by methods described herein. Note that references often provide this in a “normalized” form (i.e., a probability density function), in which the total area under the curve is unity and which has only three parameters. However, as noted previously herein, the peak area parameter A may be taken as corresponding to the number of analyte molecules contributing to the peak multiplied by a response factor.

It is here assumed that a chromatographic peak of a single analyte exhibiting peak tailing may be modeled by a four-parameter Gamma distribution function, wherein the parameters may be inferred to have relevance with regard to physical interaction between the analyte and the chromatographic column. In this case, the Gamma function may be written as:

$$I ( t ; A , {t}_{0} , M , r ) = A \frac{{{r}^{M} ( t - {t}_{0} )}^{M - 1} {e}^{- r ( t - {t}_{0} )}}{Γ ( M )} t \geq {t}_{0} \qquad Eq . 2 a$$

in which t is retention time (the independent variable), A is peak area, t₀ is lag time and M is the mixing number. Note that if M is a positive integer then Γ(M)=(M−1)! and the distribution function given above reduces to the Erlang distribution. The adjustable parameters in the above are A, t₀, M and r. FIG. 14 illustrates four different Gamma distribution functions for which the only difference is a change in the value of the mixing parameter, M. For curves 222, 224, 226 and 228, the parameter M is given by M=2, M=5, M=20 and M=100, respectively. In the limit of high M, the Gamma function approaches the form of a Gaussian function.

The general, four-parameter form of the exponentially modified Gaussian (EMG) distribution, as used in methods described herein, is given by a function of the form:

$$I ( x ; A , {x}_{0} , {σ}^{2} , τ ) = A {\int }_{- ∞}^{x} \frac{1}{σ \sqrt{2 π}} {e}^{- {( u - {x}_{0} )}^{2} / 2 {σ}^{2}} \frac{1}{τ} {e}^{- ( x - u ) / τ} d u \\ ( x \geq 0 ; τ > 0 ) . \qquad Eq . 3$$

Thus, the EMG distribution used herein is defined as the convolution of an exponential distribution with a Gaussian distribution. In the above Eq. 3, the independent and dependent variables are x and I, as previously defined and the parameters are A, t₀, σ², and τ. The parameter A is the area under the curve and is proportional to analyte concentration and the parameters t₀ and σ² are the centroid and variance of the Gaussian function that modifies an exponential decay function. An exponentially-modified Gaussian distribution function of the form of Eq. 3 may be used to model some chromatographic peaks exhibiting peak tailing. In this situation, the general variable x is replaced by the specific variable time t and the parameter x₀ is replaced by t₀.

FIG. 15 illustrates, in greater detail, various sub-steps that may be included in the step 512 of the method 150 (see FIG. 8 and FIG. 12). More generally, FIG. 15 outlines an exemplary method for choosing between line shape forms in the modeling and fitting of an asymmetric spectral peak. The method 512 illustrated in FIG. 15 may be entered from step 510 of the method 150 (see FIG. 12). When method 512 is entered from step 510, the skew, S, is greater than (1+ε), because the respective “No” branch has previously been executed in each of steps 509 and 510 (see FIG. 12). For instance, if is set to 0.05, then the skew is greater than 1.05. When S>(1+ε), both the EMG distribution (in the form of Eq. 3) and the Gamma distribution may be fit to the data and one of the two distributions may be selected as a model of better fit on the basis of the squared difference (chi-squared statistic).

From step 232, the method 512 (FIG. 15) proceeds to step 234. In these two steps, first one line shape and then an alternative line shape is fitted to the data and a chi-squared statistic is calculated for each. The fit is performed within a range of data points established by a pre-defined criterion. For instance, the number of data points to be used in the fit may be calculated by starting with a pre-set number of points, such as 12 points and then adjusting, either increasing or decreasing, the total number of data points based on an initial estimated peak width. Preferably, downward adjustment of the number of points to be used in the fit does not proceed to less than a certain minimum number of points, such as, for instance, five points.

Alternatively, the fit may be mathematically anchored to the three points shown in FIG. 13. Alternatively, the range may be defined as all points of the peak occurring above the noise threshold. Still further alternatively, the range may be defined via some criterion based on the intensities of the points or their intensities relative to the maximum point 216, or even on criterion based wholly or in part on calculation time. Such choices will depend on the particular implementation of the method, the relative requirements for calculation speed versus accuracy, etc. Finally, in step 236, the fit function is chosen as that which yields the lesser chi-squared. The method 512 then outputs the results or exits to step 516 of method 150 (see FIG. 12).

Returning, once again, to the method 48 as shown in FIG. 8, it is noted that, after all peaks have been fit in step 150, the next optional step, step 170 comprises refinement of the initial parameter estimates for multiple detected chromatographic peaks. Refinement comprises exploring the space of N parameters (the total number of parameters across all peaks, i.e. 4 for each Gamma/EMG and 3 for each Gaussian) to find the set of values that minimizes the sum of squared differences between the observed and model chromatogram. Preferably, the squared difference may be calculated with respect to the portion of the chromatogram comprising multiple or overlapped peaks. It may also be calculated with respect to the entire chromatogram. The model chromatogram is calculated by summing the contribution of all peaks estimated in the previous stage. The overall complexity of the refinement can be greatly reduced by partitioning the chromatogram into regions that are defined by overlaps between the detected peaks. In the simplest case, none of the peaks overlap, and the parameters for each individual peak can be estimated separately.

The refinement process continues until a halting condition is reached. The halting condition can be specified in terms of a fixed number of iterations, a computational time limit, a threshold on the magnitude of the first-derivative vector (which is ideally zero at convergence), and/or a threshold on the magnitude of the change in the magnitude of the parameter vector. Preferably, there may also be a “safety valve” limit on the number of iterations to guard against non-convergence to a solution. As is the case for other parameters and conditions of methods described herein, this halting condition is chosen during algorithm design and development and not exposed to the user, in order to preserve the automatic nature of the processing. At the end of refinement, the set of values of each peak area along with a time identifier (either the centroid or the intensity maximum) is returned. The entire process is fully automated with no user intervention required.

### Section 4. Application to Three-Variable LC-MS Data

### 4.1. Line Shape Reproduction by Parameterless Peak Detection Methods

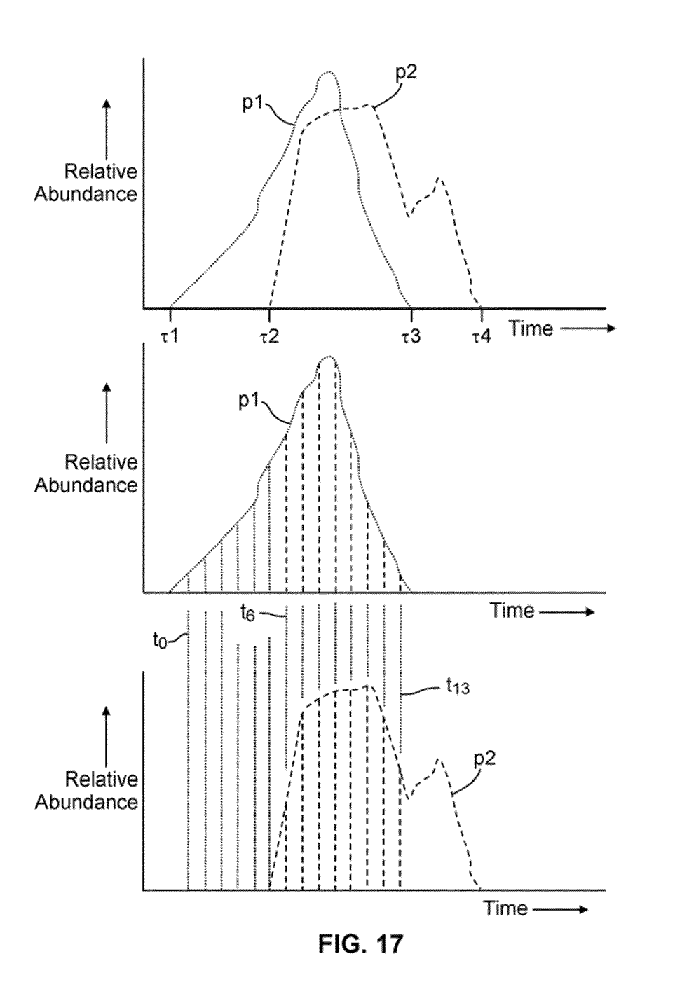

The extracted ion chromatogram (XIC) peak shapes for components that elute at similar times are not all the same, neither are they all different. FIG. 16 shows results from a typical situation, in which the peak shapes in various extracted ion chromatograms fall into several groups of patterns indicated by the peak profiles s1-s8. Comparisons between the schematically illustrated XIC peak profiles in FIG. 4A illustrate how precursor-ion profiles may be similar in shape to the profiles of product ions—e.g., fragment ions or adduct ions wherein the adducted groups arise from background compounds present in relatively constant amounts or in excess relative to analyte compounds—relating to elution of the analyte same compounds FIG. 4A also illustrates how profiles relating to elution of different compounds may be expected to have different respective shapes. Since the chemistry and physics that determine the chromatographic peak shape are unique for each molecule and cease when the molecule exits the column, one can expect that XICs having similar shapes may be related. By using Parameterless Peak Detection (PPD) techniques, as described in Section 2 herein, to characterize the peak shape, small differences in shape can be encoded in a correlation vector (described in more detail following). This can be enhanced by additional smoothing after the peak is detected (but not before, since prior smoothing can smooth a noise spike into a peak). Step 59 of method 40 (FIG. 6A) is the cross-correlation step which is described in more detail in the following section.

### 4.2. Cross Correlation Calculations

Overall cross-correlation scores (CCS) in accordance with the methods described herein may be calculated (i.e., in step 59 of method 40) according to the following strategy. For each mass in the experimental data that is found to form a chromatographic peak by PPD as described in Section 3, the cross correlation of every mass with every other mass is computed. In the present context, the term “peak” refers simply to masses (i.e., ion types) that have non-zero intensity values for several contiguous or nearly contiguous scans (for example, the scans at times rt1, rt2, rt3 and rt4 illustrated in FIG. 4A). Each cross-correlation score may be calculated as a weighted average of a peak shape correlation score (calculated in terms of a time-versus-intensity for each mass that forms a recognized peak), in conjunction with an optional mass defect correlation score (for differences along the m/z axis) and an optional peak width correlation score as described below. If a calculated overall correlation score is such that a match between masses is recognized, then a precursor/product relationship between correlated ions may be recognized.

A trailing retention time window may be used to calculate peak-shape cross correlations. The correlation calculations may make use of a numerical array including mass, intensity, and scan number values for every mass that forms a chromatographic peak. As described in Section 3, Parameterless Peak Detection (PPD) may used to calculate a peak shape for each mass component. This shape may be a simple Gaussian or Gamma function peak, or it may be a sum of many Gaussian or Gamma function shapes, the details of which are stored in a peak parameter list. Once the component peak shape has been characterized by an analytical function (which may be a sum of simple functions), it becomes a trivial matter to calculate a cross correlation, here considered as a simple vector product (“dot product”). These cross correlations are normalized by also calculating, and dividing by, the autocorrelation values. Consequently, the peak shape correlation (PSC) between two peak profiles, p1 and p2 (denoted, functionally as p1(t) and p2(t), where t represents a time variable, may be calculated as

$$PSC ( p 1 , p 2 ) = \frac{{\sum }_{j = j min}^{j = j max} [ p 1 ( {t}_{j} ) \times p 2 ( {t}_{j } ) ]}{{\{ {\sum }_{j = j min}^{j = j max} p 1 {( {t}_{j} )}^{2} \}}^{1 \text{/} 2} {\{ {\sum }_{j = j min}^{j = j max} p 2 {( {t}_{j} )}^{2} \}}^{1 \text{/} 2}} \qquad Eq . 4$$

in which the time axis is considered as divided into equal width segments, thus defining indexed time points, tⱼ, ranging from a practically defined lower time bound, t_{j min}, to a practically defined upper time bound, t_{j max}. Accordingly, the quantity PSC can theoretically have a range of 1 (perfect correlation) to −1 (perfect anti-correlation), but since negative going chromatographic peaks are not detected by PPD (by design) the lower limit is effectively zero. For example, the lower and upper time bounds, t_{j min}, and, t_{j max}, may be set in relation to each precursor ion. In such a case, the time values are chosen so as to sample intensities a fixed number of times (for instance, between roughly seven and fifteen times, such as eleven times) across the width of a precursor ion peak. The masses to be correlated with the chosen precursor ion then use the same time points. This means that if these masses form a peak at markedly different times, the intensities will be essentially zero. Partially overlapped peaks will have some zero terms.

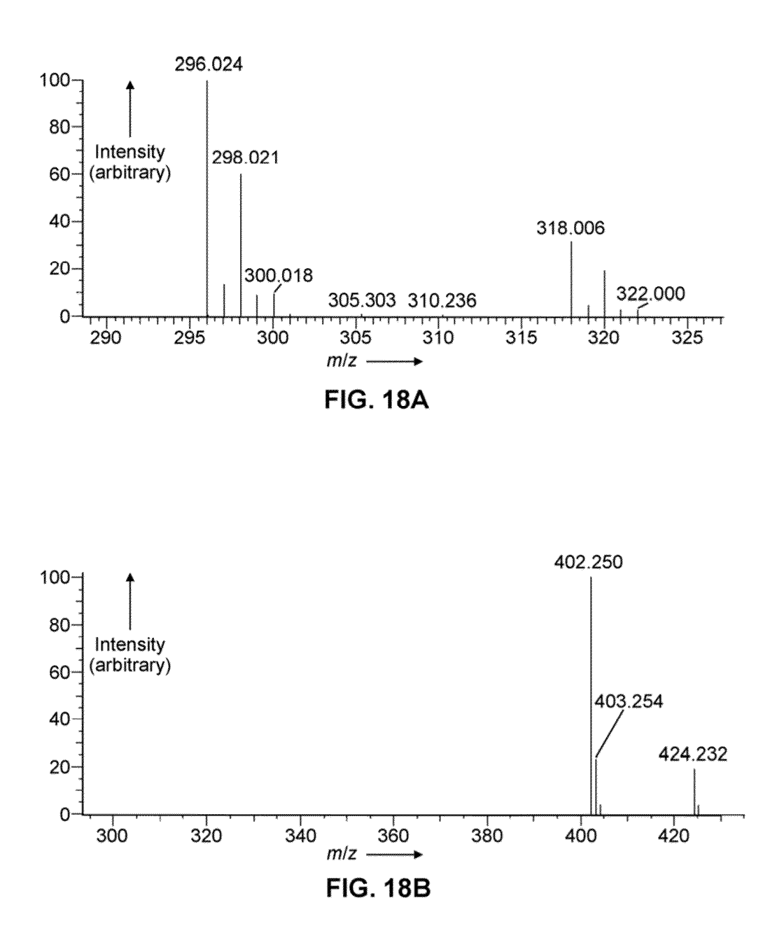

FIG. 17 graphically illustrates calculation of a dot product cross-correlation score in this fashion. In FIG. 17, two XIC peak profiles p1 and p2 are reproduced from FIG. 4. Peak p1 has appreciable intensity above baseline only between time points τ1 and τ3 and peak p2 has appreciable intensity only between time points τ2 and τ4. Assume that peak profile p1 corresponds to a precursor ion (or precursor ion candidate) and that peak p2 corresponds to a product ion (or product ion candidate). As discussed above, to calculate the dot-product cross correlation score between these two peaks, the retention time axis may be considered as being divided into several equal segments between time points τ1 and τ3, thereby defining, in this example, indexed time points tⱼ where (0≦j≦13). The two peak profiles are shown separately in the lowermost two graphs of FIG. 17 in association with vertical lines representing the various indexed time points along the retention time axis. In this representation, peak p2 only has appreciable intensity between the points t₆ and t₍₁₃₎. Thus, in this example, the peak shape correlation is given by

$$PSC ( p 1 , p 2 ) = \frac{{\sum }_{j = j min}^{j = j max} [ p 1 ( {t}_{j} ) \times p 2 ( {t}_{j } ) ]}{{\{ {\sum }_{j = 0}^{j = 13} p 1 {( {t}_{j} )}^{2} \}}^{1 \text{/} 2} {\{ {\sum }_{j = 0}^{j = 13} p 2 {( {t}_{j} )}^{2} \}}^{1 \text{/} 2}}$$

Under such a calculation, the cross-correlation score, as calculated above, for the peaks p1 and p2 illustrated in FIG. 17 would be a positive number because the peaks partially overlap, but would be below a threshold score for recognizing a peak match, since the peaks have different shapes. The cross-correlation score for a peak with itself or with a scaled version of itself is unity. Note from FIG. 4A that, by this measure, the peaks p4 and f4 would have a high cross-correlation score even though they have different magnitudes. In the same fashion, peak p2 would strongly correlate with peak f2 and peak p1 would strongly correlate with peak f1. By contrast, the cross-correlation score between the peaks p3 and p4 illustrated in FIG. 4B would be essentially zero because these peaks have no overlap (every term in the numerator of Eq. 4 would be essentially zero).

The correlation method also may also calculate and include a mass defect correlation. The mass defect is simply the difference, Δm, between the unit resolution mass and the actual mass, expressed in a relative sense such as parts per million (ppm). Thus the mass defect for a peak, p, can be expressed as:

$${MD}_{p} = 1000000 \times \frac{Δ {m}_{p}}{{m}_{p}} \qquad Eq . 5$$

FIG. 4C illustrates how the quantities Δm₃ and Δm₄ may be determined for the peaks p3 and p4, respectively. Note that the sign of the mass defect is negative for peak p3 and positive for peak p4. The peaks p3 and p4 illustrated in FIG. 4C are the same peaks as illustrated in FIG. 4B, but are shown along the mass axis instead of the orthogonal time axis, as in FIG. 4B. Thus, the mass defect provides an independent measure of the potential relatedness of the peaks. This is true in the broadest sense if one considers the mass defect to arise from numerous small contributions from all the atoms in the structure, and the fragments to be of composition typical to the whole. So, for example, an alkane chain that is fragmented will have the same mass defect (on a relative basis) in both halves. On the other hand, chlorobenzene that is fragmented into benzene and chloride ions will have markedly different mass defects. Likewise, the mass defect correlation may not work well for the correlation of adducts with their precursors.

The mass defect correlation, MDC_{(p1,p2)}, between two peaks p1 and p2, is computed simply as

MDC_{(p1,p2)}=1−A(MDₚ₁−MDₚ₂) Eq. 6

where A is a suitable multiplicative constant. Therefore the mass defect correlation ranges from 1 (exactly the same relative defect) to some small number that depends on the value of A.

If it is desired to also use a peak width correlation, which is calculated by a similar formula, using the absolute peak widths as determined by PPD on the XIC peak shapes. Accordingly, an optional peak width correlation, PWC_{(p1,p2)}, between peaks p1 and p2 may be calculated by

PWC_{(p1,p2)}=1−B|widthₚ₁−widthₚ₂| Eq. 7

in which B is the inverse of the maximum of widthₚ₁ and widthₚ₂ and the vertical bars represent the mathematical absolute value operation.

The cross-correlation score calculation, as shown in step 59 of method 40 (FIG. 6A) may be calculated by combining the peak-shape correlation score, PSC, together with the mass defect correlation score, MDC, and possibly with the peak width correlation score, PWC, as a weighted average. Accordingly, the overall correlation score, CCS_{(p1,p2)}, is given by

CCS_{(p1,p2)}={X[PSC_{(p1,p2)}]+Y[MDC_{(p1,p2)}]+Z[PWC_{(p1,p2)}]}/{X+Y+Z}Eq. 8

in which X, Y and Z are weighting factors. Thus, the overall score, CCS, ranges from 1.0 (perfect match) down to 0.0 (no match). Peak matches are recognized when a correlation exceeds a certain pre-defined threshold value. Experimentally, it is observed that limiting recognized matches to scores to those above 0.90 provides reconstructed MS/MS spectra that match extremely well to experimental spectra.

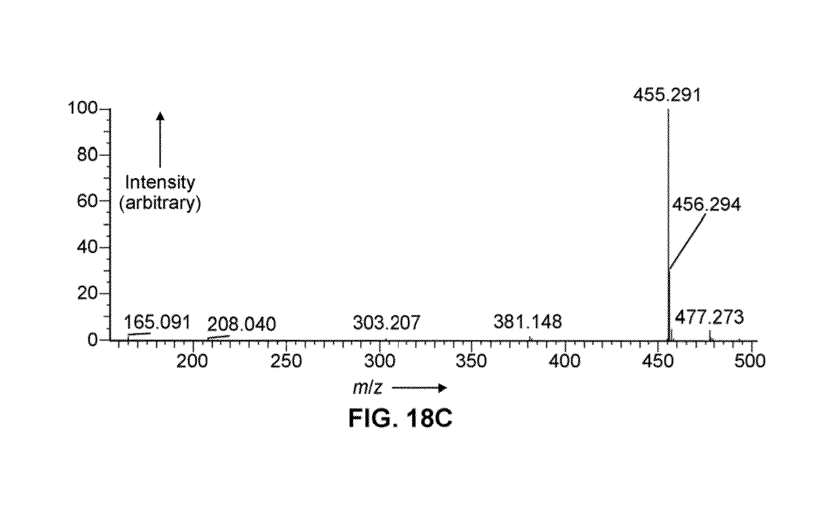

FIGS. 18A-18C are examples of experimentally determined mass spectra illustrating various adduct and fragment ions generated in the ion source and identified employing methods in accordance with the present teachings. Numbers positioned above selected mass spectral lines in FIGS. 18A-18C are the mass-to-charge (m/z) values of those lines. Although the measurements were obtained with four-decimal-place precision, the m/z values are only shown as rounded to three decimal places for clarity. The mass spectra shown in FIGS. 18A-18C are filtered in the sense that only those points exhibiting large cross-correlation scores in accordance with the present teachings are shown.

FIG. 18A shows a filtered mass spectrum of Diclofenac, which is a common nonsteroidal anti-inflammatory drug. In addition to lines characteristic of the monoisotopic protonated ion and several chlorine isotopes of that ion, the spectrum also exhibits a line corresponding to a sodium adduct of the non-protonated parent ion at an m/z value of 318, and several chlorine isotopes of the sodium adduct. The recognition of the sodium adduct ion at m/z 318 is enabled by a cross-correlation score of 0.998 (out of 1.00) with the monoisotopic protonated molecule at m/z 296.

FIG. 18B is a filtered mass spectrum of the an anxiolytic psychoactive drug Buspirone, which exhibits a line corresponding to an oxidation product at an m/z value of 402, as well as a sodium adduct of that oxidation product at m/z 424. These lines are identified by their respective cross-correlation scores of 1.000 and 0.980. FIG. 18C shows a filtered mass spectrum of Verapamil, which is an L-type calcium channel blocker of the phenylalkylamine class. In addition to a line corresponding to the protonated molecule (at an m/z value of 455), the spectrum exhibits an in-source fragment at m/z 303 (cross-correlation score of 0.959) which is one of the dimethoxymethlybenzene end parts of the precursor ion. The spectrum also shows a line corresponding to a sodium adduct at m/z 477 (cross-correlation score of 0.981).

### CONCLUSION

The end result of methods described in the preceding text and associated figures is a general method to detect peaks and recognize matches between precursor ions and product ions generated in gas phase reactions, by in-source fragmentation, or both. Since these require no user input, they are suitable for automation, use in high-throughput screening environments or for use by untrained operators. The disclosed methods are capable of identifying m/z values in full-scan mass spectrometry data that are correlated by elution lineshape and, optionally, are correlated by mass defect or peak width. Methods in accordance with the present teachings are capable of grouping related m/z values and assigning their respective ion types as derivatives of a common progenitor ion type, corresponding to its own respective m/z value. These recognized groupings use correlation scores to give statistical confidence that the assignments are real and not associations of chance. When used in conjunction with high-mass-accuracy mass spectral scan data, methods in accordance with the present teachings are capable of simplifying spectra and suggesting possible adducts or other gas phase chemistry without operator intervention. These methods are useable in conjunction with any LC/MS or GC/MS instrument. High mass accuracy, while helpful, is not a requirement.

Although the described methods are somewhat computationally intensive, they are nonetheless able to process data faster than it is acquired, and so can be done in real time, so as to make automated real-time decisions about the course of subsequent mass spectral scans on a single sample or during a single chromatographic separation. Such real-time (or near-real-time) decision making processes require data buffering since chromatographic peaks are searched for in a moving window of time. The methods as disclosed herein may provide a listing of components found, with details presented including but not limited to, chromatographic retention time and peak width, ion mass, and signal to noise characteristics.

The discussion included in this application is intended to serve as a basic description. Although the invention has been described in accordance with the various embodiments shown and described, one of ordinary skill in the art will readily recognize that there could be variations to the embodiments and those variations would be within the spirit and scope of the present invention. The reader should be aware that the specific discussion may not explicitly describe all embodiments possible; many alternatives are implicit. Accordingly, many modifications may be made by one of ordinary skill in the art without departing from the scope and essence of the invention. Neither the description nor the terminology is intended to limit the scope of the invention. Any patents, patent applications, patent application publications or other literature mentioned herein are hereby incorporated by reference herein in their respective entirety as if fully set forth herein.

What is claimed is:

1. A method for matching each one of a plurality of progenitor ion types to its respective product or fragment ion types generated by reaction of the progenitor ion type, comprising:
generating the plurality of progenitor ion types over a time range by ionizing compounds eluting from a chromatograph during the time range using an atmospheric pressure ion source of a mass spectrometer system;
passing the plurality of progenitor ion types through an ionization chamber and a first vacuum chamber of the mass spectrometer system so as to generate the product or fragment ion types in said chambers during the time range, wherein pressures within said chambers are within a pressure range of 750 mTorr to atmospheric pressure;
detecting abundances of the plurality of progenitor ion types and the product or fragment ion types using a mass analyzer of the mass spectrometer system;
calculating a plurality of extracted ion chromatograms (XICs) relating to the detected abundances;
automatically detecting and characterizing chromatogram peaks within each XIC and automatically generating synthetic analytical fit peaks thereof;
performing a respective cross-correlation score calculation between each pair of synthetic analytical fit peaks; and
recognizing matches between each of the progenitor ion types and to its respective product or fragment ion types based on the cross correlation scores.

2. A method as recited in claim 1, further comprising discarding a subset of the synthetic analytical peaks which do not satisfy noise reduction rules prior to performing the cross-correlation score calculations.

3. A method as recited in claim 2, wherein the discarding of the subset of the synthetic analytical peaks comprises:
comparing an area, Aⱼ, of each synthetic analytical fit peak of each respective XIC to a total area, ΣA, of the respective XIC;
comparing an intensity, Iⱼ, of each synthetic analytical fit peak of each respective XIC to an average peak intensity, Iₐᵥₑ, of the respective XIC; and
discarding synthetic analytical fit peaks for which (Aⱼ/ΣA)<ω or that (Iⱼ/Iₐᵥₑ)<ρ, in which ω and ρ are pre-determined constants.

4. A method as recited in claim 1, wherein the step of performing a respective cross-correlation score calculation between each pair of synthetic analytical fit peaks includes calculating a peak shape correlation (PSC) between each pair (p1, p2) of synthetic analytical peak profiles.

5. A method as recited in claim 4, wherein the peak shape correlation (PSC) between each pair (p1, p2) of synthetic analytical peak profiles is calculated as
$$PSC ( p 1 , p 2 ) = \frac{{\sum }_{j = j min}^{j = j max} [ p 1 ( {t}_{j} ) \times p 2 ( {t}_{j } ) ]}{{\{ {\sum }_{j = j min}^{j = j max} p 1 {( {t}_{j} )}^{2} \}}^{1 \text{/} 2} {\{ {\sum }_{j = j min}^{j = j max} p 2 {( {t}_{j} )}^{2} \}}^{1 \text{/} 2}}$$
in which p1(tⱼ) and p2(tⱼ) are the values of the synthetic analytical peak profiles, p1 and p2, respectively, at each j^{th} time point and wherein j min and j max are defined lower and upper indices, respectively.

6. A method as recited in claim 1, wherein the step of generating the plurality of progenitor ion types over a time range comprises generating the plurality of progenitor ion types over a time range of less than or equal to 0.6 minutes.

7. A method as recited in claim 1, further comprising automatically controlling operation, during a subsequent time range, of the mass spectrometer system, wherein said controlling is based upon the automatically recognized matches between the progenitor ion types and product or fragment ion types.

8. A method as recited in claim 7, wherein the step of automatically controlling operation of the mass spectrometer system includes adjusting operation of the ion source or adjusting an accelerating potential that is applied to the progenitor ions within the first vacuum chamber.

9. A method as recited in claim 1, wherein the product or fragment ion types are formed by one or more of adduction of species other than H+ to progenitor ion types, dehydration of progenitor ion types, dimerization of progenitor ion types, or collection of transfer of charge to progenitor ion types.

10. A method as recited in claim 1, wherein the detecting step comprises generating a plurality of mass spectra, wherein the recognizing of matches between each of the progenitor ion types and to its respective product or fragment is used to eliminate mass spectral peaks which coincidentally overlap with peaks corresponding to isotopic distribution patterns in a mass spectrum, wherein the isotopic distribution patterns are recognized by the elimination of the coincidentally overlapping peaks.

11. A method as recited in claim 1, wherein the product or fragment ion types are formed by the process of in-source fragmentation.

12. An apparatus comprising:
a chromatograph for providing a stream of at least partially separated chemical substances;
a mass spectrometer having an atmospheric pressure ion source within an ionization chamber fluidically coupled to the chromatograph for generating one or more progenitor ion types from each chemical substance;
a first vacuum chamber of the mass spectrometer operable to receive the progenitor ion types, the interior of which is at a pressure in a range of 750 mTorr to 50 Torr;
a set of electrodes operable to apply an accelerating potential to the progenitor ion types within or across at least one of the ionization chamber or the first vacuum chamber so as to generate a plurality of product ion types by in-source fragmentation;
a mass analyzer and detector of the mass spectrometer operable to receive and detect abundance data for each progenitor ion type and each product ion type; and
a programmable electronic processor electrically coupled to the detector, the programmable processor comprising instructions operable to cause the programmable processor to:
receive the abundance data for each of the progenitor ion types and product ion types detected by the detector during a time range;
automatically detect and characterize chromatogram peaks as a function of time for each of a plurality of mass-to-charge ratio ranges of the abundance data for the progenitor ion types and product ion types;
automatically generate synthetic analytical fit peaks to the detected chromatogram peaks;
automatically perform a respective cross-correlation score calculation between each pair of synthetic analytical fit peaks; and
automatically recognize matches between progenitor ion types and product ion types based on the cross correlation scores.

13. An apparatus as recited in claim 12, wherein the programmable electronic processor is further electrically coupled to one or more of the chromatograph, the ion source or the set of electrodes and wherein the instructions are further operable to cause the programmable processor to:
adjust operation of the chromatograph, the ion source or the electrodes during generation of a second plurality of progenitor ion types and a second plurality of product ion types during a second, subsequent time range, wherein said adjustment is based on the automatically recognized matches between progenitor ions and product ions.

14. An apparatus as recited in claim 12, wherein the instructions operable to cause the programmable processor to automatically detect and characterize chromatogram peaks as a function of time is operable to cause the programmable processor to automatically detect and characterize the chromatogram peaks as a function of time in the absence of any user input parameters.

15. An apparatus as recited in claim 12, wherein the set of electrodes is operable to apply the accelerating potential across at least a portion of an ion transfer tube that fluidically interconnects the ionization chamber and the first vacuum chamber

16. An apparatus as recited in claim 12, wherein the instructions are further operable to cause the programmable processor to:
automatically recognize matches, based on the cross correlation scores, between progenitor ion types and ion types formed by one or more of adduction of species other than H+ to progenitor ion types, dehydration of progenitor ion types, dimerization of progenitor ion types, or collection of transfer of charge to progenitor ion types.

17. An apparatus as recited in claim 12, wherein the instructions are further operable to cause the programmable processor to:
automatically generate a plurality of mass spectra during the automatic detection and characterize of chromatogram peaks;
automatically subtract mass spectral peaks corresponding to the recognized product or fragment ion types from at least one mass spectrum so as to generate a calculated mass spectrum; and
automatically recognize isotopic distribution patterns within the calculated mass spectrum.
